(19) United States
(12) Patent Application Publication
(10) Pub. No.: US 2025/0251486 A1
(43) Pub. Date: Aug. 7, 2025

(54) INTEGRATING AUDIO SIGNAL INFORMATION FOR POSITIONING AND SENSING

(71) Applicant: QUALCOMM Incorporated, San Diego, CA (US)

(72) Inventors: Marko ANGJELICHINOSKI, San Diego, CA (US); Sony AKKARAKARAN, Poway, CA (US)

(21) Appl. No.: 18/435,910

(22) Filed: Feb. 7, 2024

(51) Int. Cl. G01S 5/22; G01S 5/02

(52) U.S. Cl. CPC G01S 5/22; G01S 5/0263

(57) ABSTRACT

Disclosed are techniques for audio positioning. In an aspect, a network entity may receive radiofrequency (RF) signaling from a user equipment (UE). The network entity may determine to activate audio positioning for the UE based on one or more criteria. The network entity may transmit audio positioning configuration information to the UE. The network entity may receive positioning information for the UE in accordance with the audio positioning configuration information, the positioning information for the UE including audio measurement information or a location estimate of the UE based on audio measurements.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method at a network entity comprising: receiving radiofrequency (RF) signaling from a user equipment (UE); determining to activate audio positioning for the UE based on one or more criteria; transmitting audio positioning configuration information to the UE; and receiving positioning information for the UE in accordance with the audio positioning configuration information, the positioning information for the UE including audio measurement information or a location estimate of the UE based on audio measurements.

In an aspect, a method of wireless communication for a user equipment (UE) comprising: obtaining one or more measurements of radiofrequency (RF) signals; receiving audio positioning configuration information from a network entity; transmitting audio signals, detecting audio signals, or both, according to the audio positioning configuration information; and transmitting information indicative of the detected audio signals, the transmitted audio signals, or both to the network entity.

In an aspect, a network entity includes one or more memories; one or more transceivers; and one or more processors communicatively coupled to the one or more memories and the one or more transceivers, the one or more processors, either alone or in combination, configured to: receive, via the one or more transceivers, radiofrequency (RF) signaling from a user equipment (UE); determine to activate audio positioning for the UE based on one or more criteria; transmit, via the one or more transceivers, audio positioning configuration information to the UE; and receive, via the one or more transceivers, positioning information for the UE in accordance with the audio positioning configuration information, the positioning information for the UE including audio measurement information or a location estimate of the UE based on audio measurements.

In an aspect, a user equipment includes one or more memories; one or more transceivers; and one or more processors communicatively coupled to the one or more memories and the one or more transceivers, the one or more processors, either alone or in combination, configured to: obtain one or more measurements of radiofrequency (RF) signals; receive, via the one or more transceivers, audio positioning configuration information from a network entity; transmit, via the one or more transceivers, audio signals, detecting audio signals, or both, according to the audio positioning configuration information; and transmit, via the one or more transceivers, information indicative of the detected audio signals, the transmitted audio signals, or both to the network entity.

In an aspect, a network entity includes means for receiving radiofrequency (RF) signaling from a user equipment (UE); means for determining to activate audio positioning for the UE based on one or more criteria; means for transmitting audio positioning configuration information to the UE; and means for receiving positioning information for the UE in accordance with the audio positioning configuration information, the positioning information for the UE including audio measurement information or a location estimate of the UE based on audio measurements.

In an aspect, a user equipment includes means for obtaining one or more measurements of radiofrequency (RF) signals; means for receiving audio positioning configuration information from a network entity; means for transmitting audio signals, detecting audio signals, or both, according to the audio positioning configuration information; and means for transmitting information indicative of the detected audio signals, the transmitted audio signals, or both to the network entity.

In an aspect, a non-transitory computer-readable medium stores computer-executable instructions that, when executed by a network entity, cause the network entity to: receive radiofrequency (RF) signaling from a user equipment (UE); determine to activate audio positioning for the UE based on one or more criteria; transmit audio positioning configuration information to the UE; and receive positioning information for the UE in accordance with the audio positioning configuration information, the positioning information for the UE including audio measurement information or a location estimate of the UE based on audio measurements.

In an aspect, a non-transitory computer-readable medium stores computer-executable instructions that, when executed by a user equipment, cause the user equipment to: obtain one or more measurements of radiofrequency (RF) signals; receive audio positioning configuration information from a network entity; transmit audio signals, detecting audio signals, or both, according to the audio positioning configuration information; and transmit information indicative of the detected audio signals, the transmitted audio signals, or both to the network entity.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 illustrates an example Long-Term Evolution (LTE) positioning protocol (LPP) capability transfer procedure, assistance data transfer procedure, and location information transfer procedure between a target device and a location server, according to aspects of the disclosure.

FIG. 6 illustrates an example environment in which RF, vision, and/or audio positioning can be deployed, according to aspects of the disclosure.

FIG. 7 illustrates functionality of a hybrid positioning engine, according to aspects of the disclosure.

FIG. 8 illustrates an example positioning method, according to aspects of the disclosure.

FIG. 9A illustrates an example initialization method, according to aspects of the disclosure.

FIG. 9B illustrates an example database format, according to aspects of the disclosure.

FIG. 10 illustrates an example process for activating audio positioning in response to one or more detected criteria, according to aspects of the disclosure.

FIG. 11 illustrates audio positioning configuration and measurement system, according to aspects of the disclosure.

FIG. 12 shows an example method of performing audio positioning for the example technique where infrastructure and user audio devices are substantially synchronized, according to aspects of the disclosure.

FIG. 13 illustrates an example method of device-free positioning incorporation audio positioning techniques, according to aspects of the disclosure.

FIGS. 14 and 15 illustrate example methods of communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to incorporation of audio/acoustic sensing techniques. Some aspects more specifically relate to incorporating audio sensing in positioning. In some examples, audio positioning can be performed upon detection of one or more criteria. The criteria can include positioning performance criteria, radiofrequency (RF)-based criteria, location-based, criteria, vision-based criteria or other criteria. According to some aspects, the techniques can use infrastructure audio components that may already be deployed at a site, as well as user device audio components available on some user equipments (UEs).

Particular aspects of the subject matter described in this disclosure can be implemented to realize one or more of the following potential advantages. In some examples, by activating audio positioning based on one or more criteria, better positioning can be obtained in an energy-efficient way. Additionally, deployment cost may be reduced by the availability of audio components in existing infrastructure and/or user devices. In addition, aspects of the current disclosure can allow for accurate positioning in locations where vision-based positioning is restricted or prohibited for privacy reasons.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (CNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

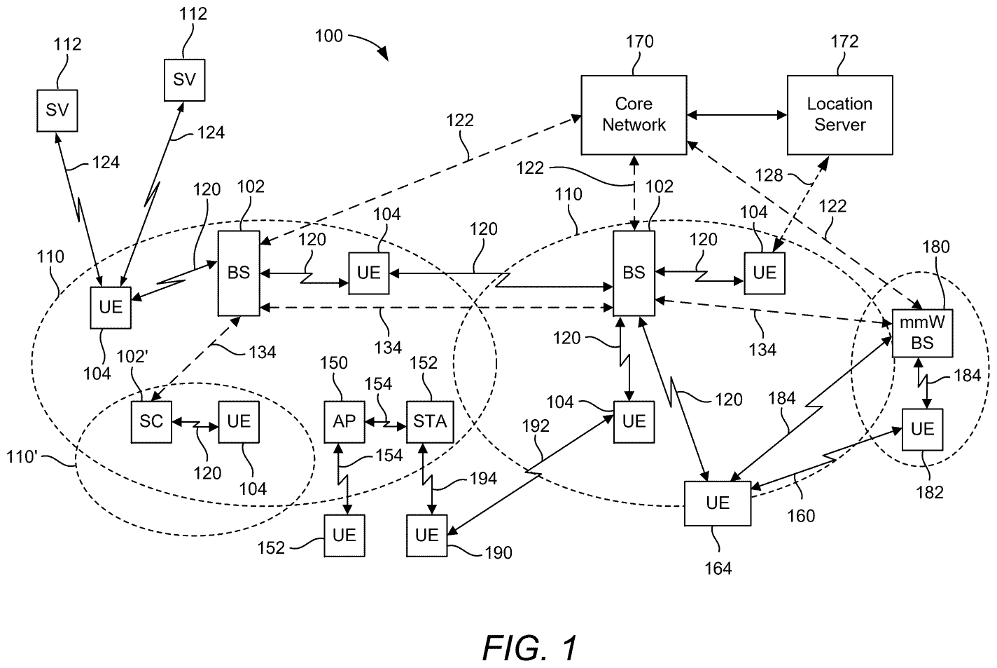

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHZ), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (cV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

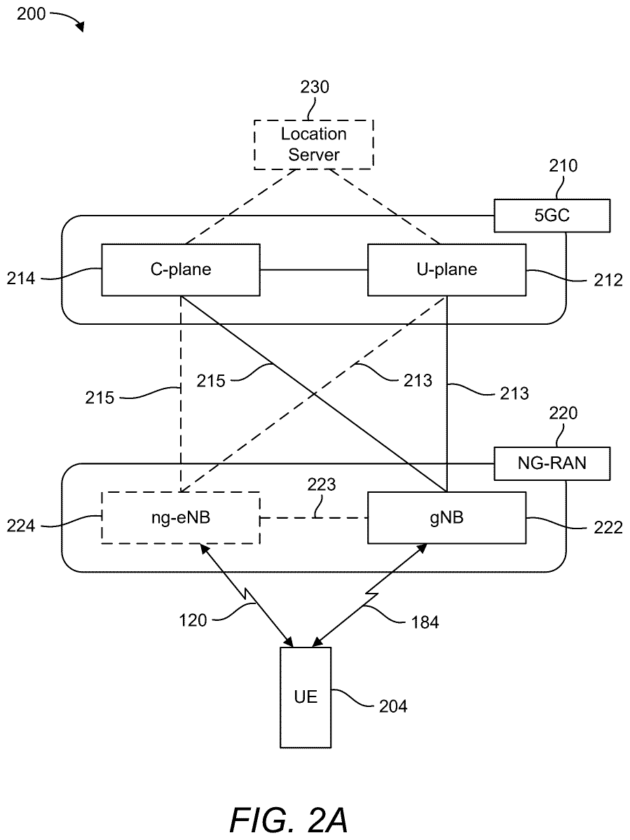

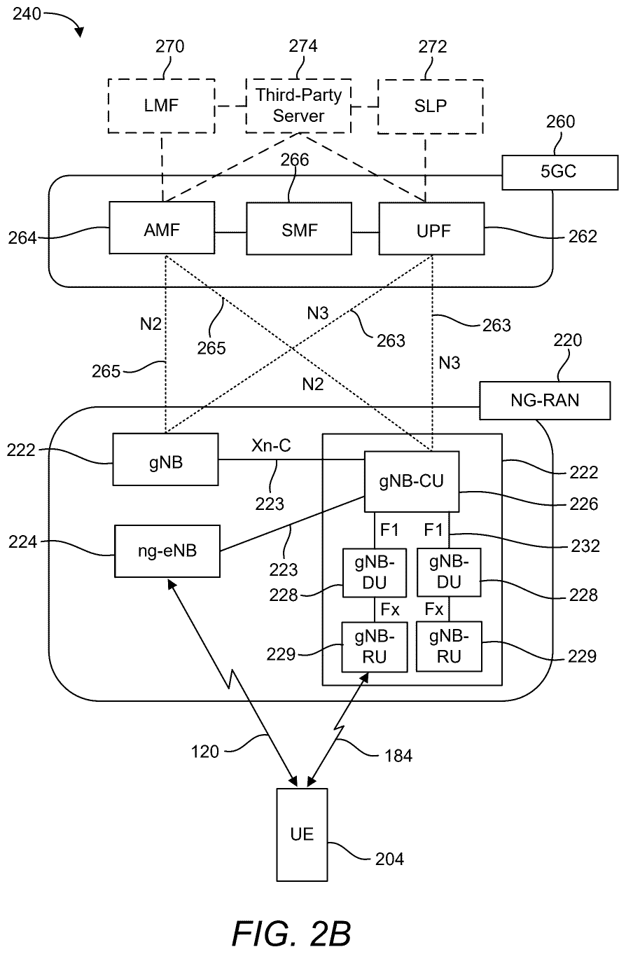

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

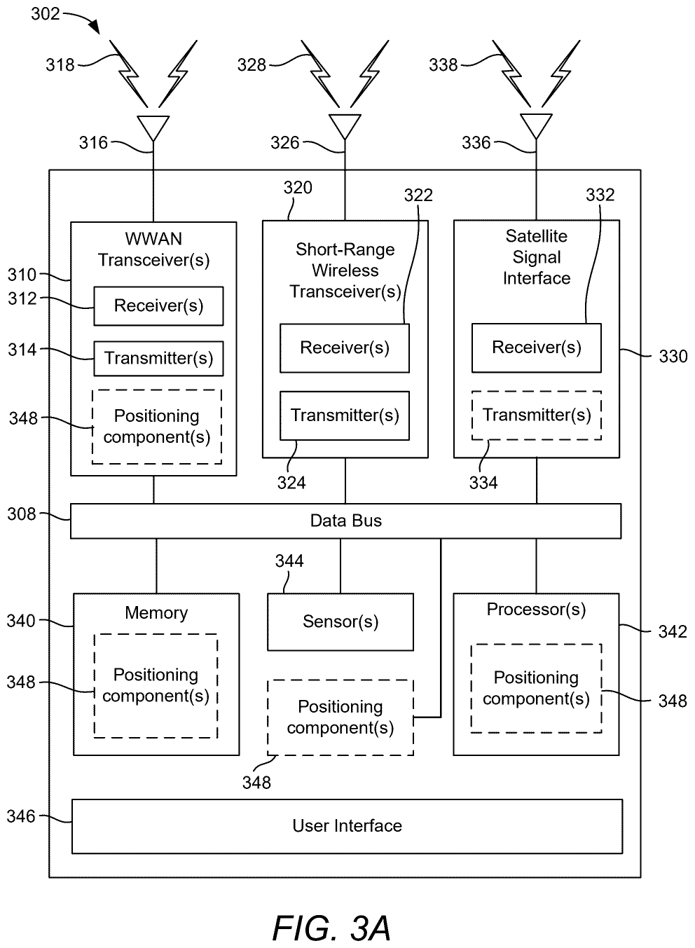

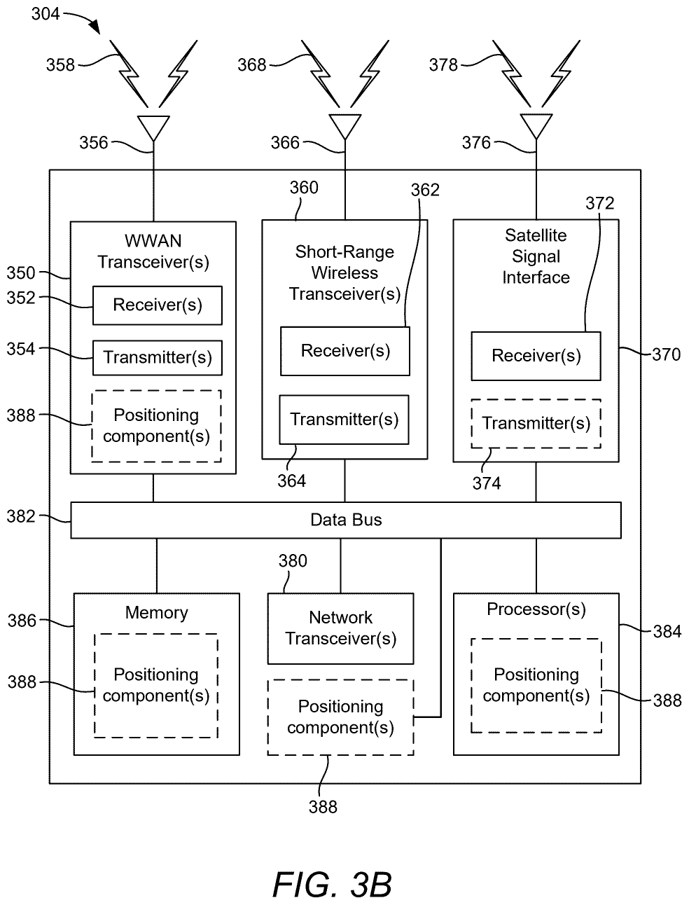

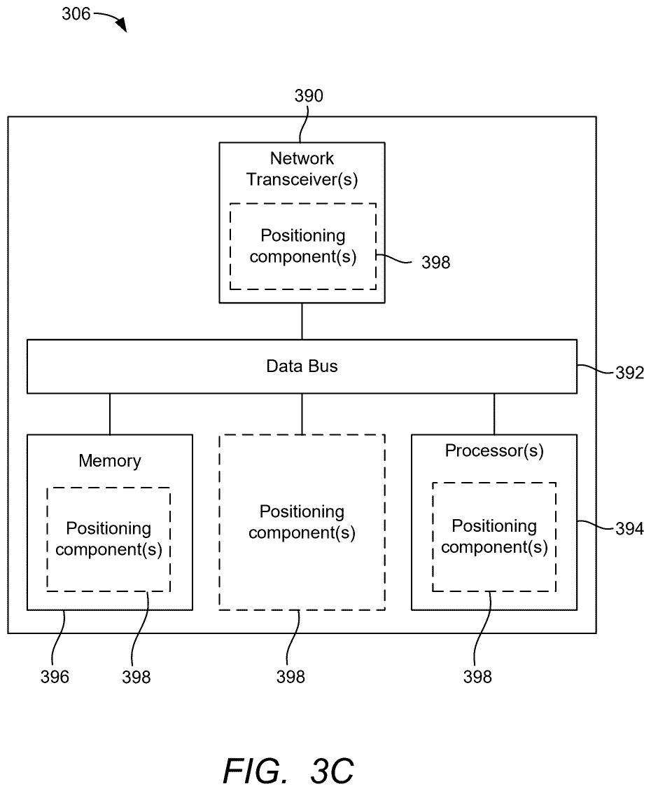

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEER and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component(s) 348, 388, and 398, respectively. The positioning component(s) 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the positioning component(s) 348, 388, and 398 may be external to the processors 342, 384, and 394 (e.g., part of a modem processing system, integrated with another processing system, etc.). Alternatively, the positioning component(s) 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component(s) 348, which may be, for example, part of the one or more WWAN transceivers 310, the memory 340, the one or more processors 342, or any combination thereof, or may be a standalone component. FIG. 3B illustrates possible locations of the positioning component(s) 388, which may be, for example, part of the one or more WWAN transceivers 350, the memory 386, the one or more processors 384, or any combination thereof, or may be a standalone component. FIG. 3C illustrates possible locations of the positioning component(s) 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component(s) 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

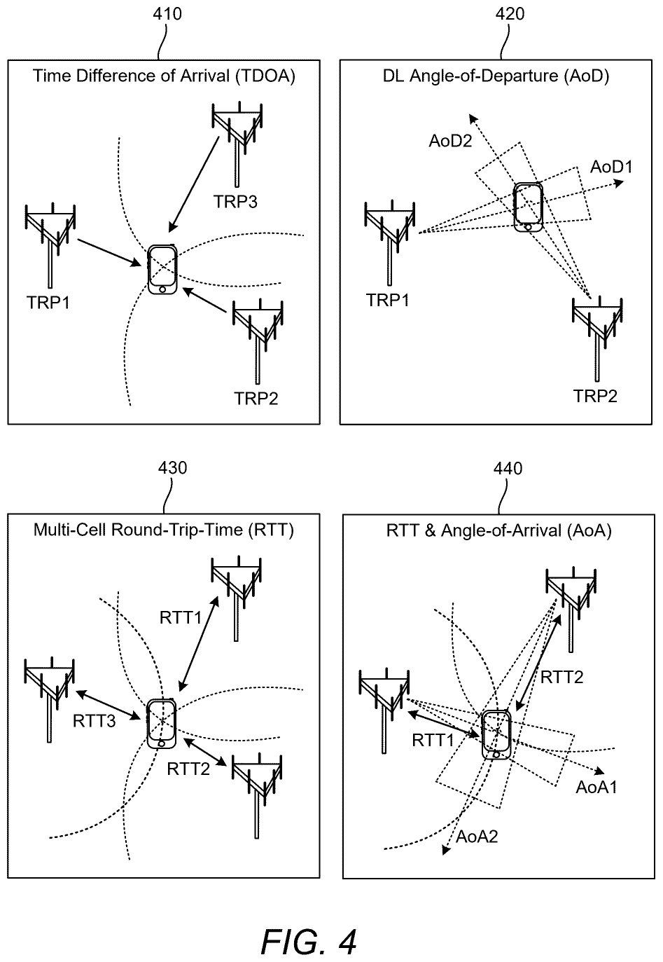

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

Long-Term Evolution (LTE) positioning protocol (LPP) is used point-to-point between a location server (e.g., LMF 270) and a target device (e.g., a UE) in order to position the target device using position-related measurements obtained by one or more reference sources (physical entities or parts of physical entities that provide signals that can be measured by a target device in order to obtain the location of the target device). An LPP session is used between a location server and a target device in order to obtain location-related measurements or a location estimate or to transfer assistance data. Currently, a single LPP session is used to support a single location request and multiple LPP sessions can be used between the same endpoints to support multiple different location requests. Each LPP session comprises one or more LPP transactions (or procedures), with each LPP transaction performing a single operation (capability exchange, assistance data transfer, or location information transfer). Each LPP transaction involves the exchange of one or more LPP messages between the location server and the target device. The general format of an LPP message consists of a set of common fields followed by a body. The body (which may be empty) contains information specific to a particular message type. Each message type contains information specific to one or more positioning methods and/or information common to all positioning methods.

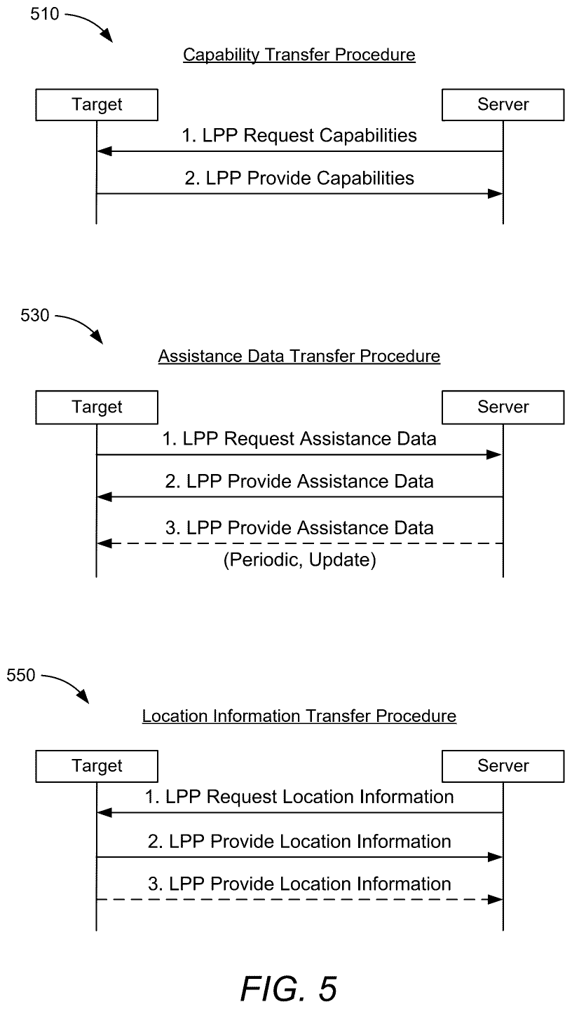

An LPP session generally includes at least a capability transfer or indication procedure, an assistance data transfer or delivery procedure, and a location information transfer or delivery procedure. FIG. 5 illustrates an example LPP capability transfer procedure 510, LPP assistance data transfer procedure 530, and LPP location information transfer procedure 550 between a target device (labeled “Target”) and a location server (labeled “Server”), according to aspects of the disclosure.

The purpose of an LPP capability transfer procedure 510 is to enable the transfer of capabilities from the target device (e.g., a UE 204) to the location server (e.g., an LMF 270). Capabilities in this context refer to positioning and protocol capabilities related to LPP and the positioning methods supported by LPP. In the LPP capability transfer procedure 510, the location server (e.g., an LMF 270) indicates the types of capabilities needed from the target device (e.g., UE 204) in an LPP Request Capabilities message. The target device responds with an LPP Provide Capabilities message. The capabilities included in the LPP Provide Capabilities message should correspond to any capability types specified in the LPP Request Capabilities message. Specifically, for each positioning method for which a request for capabilities is included in the LPP Request Capabilities message, if the target device supports this positioning method, the target device includes the capabilities of the target device for that supported positioning method in the LPP Provide Capabilities message. For an LPP capability indication procedure, the target device provides unsolicited (i.e., without receiving an LPP Request Capabilities message) capabilities to the location server in an LPP Provide Capabilities message.

The purpose of an LPP assistance data transfer procedure 530 is to enable the target device to request assistance data from the location server to assist in positioning, and to enable the location server to transfer assistance data to the target device in the absence of a request. In the LPP assistance data transfer procedure 530, the target device sends an LPP Request Assistance Data message to the location server. The location server responds to the target device with an LPP Provide Assistance Data message containing assistance data. The transferred assistance data should match or be a subset of the assistance data requested in the LPP Request Assistance Data. The location server may also provide any not requested information that it considers useful to the target device. The location server may also transmit one or more additional LPP Provide Assistance Data messages to the target device containing further assistance data. For an LPP assistance data delivery procedure, the location server provides unsolicited assistance data necessary for positioning. The assistance data may be provided periodically or non-periodically.

The purpose of an LPP location information transfer procedure 550 is to enable the location server to request location measurement data and/or a location estimate from the target device, and to enable the target device to transfer location measurement data and/or a location estimate to a location server in the absence of a request. In an LPP location information transfer procedure 550, the location server sends an LPP Request Location Information message to the target device to request location information, indicating the type of location information needed and potentially the associated QoS. The target device responds with an LPP Provide Location Information message to the location server to transfer location information. The location information transferred should match or be a subset of the location information requested by the LPP Request Location Information unless the location server explicitly allows additional location information. More specifically, if the requested information is compatible with the target device's capabilities and configuration, the target device includes the requested information in an LPP Provide Location Information message. Otherwise, if the target device does not support one or more of the requested positioning methods, the target device continues to process the message as if it contained only information for the supported positioning methods and handles the signaling content of the unsupported positioning methods by LPP error detection. If requested by the LPP Request Lactation Information message, the target device sends additional LPP Provide Location Information messages to the location server to transfer additional location information. An LPP location information delivery procedure supports the delivery of positioning estimations based on unsolicited service.

LPP also defines procedures related to error indication for when a receiving endpoint (target device or location server) receives erroneous or unexpected data or detects that certain data are missing. Specifically, when a receiving endpoint determines that a received LPP message contains an error, it can return an Error message to the transmitting endpoint indicating the error or errors and discard the received/erroneous message. If the receiving endpoint is able to determine that the erroneous LPP message is an LPP Error or Abort Message, then the receiving endpoint discards the received message without returning an Error message to the transmitting endpoint.

LPP also defines procedures related to abort indication to allow a target device or location server to abort an ongoing procedure due to some unexpected event (e.g., cancellation of a location request by an LCS client). An Abort procedure can also be used to stop an ongoing procedure (e.g., periodic location reporting from the target device). In an Abort procedure, a first endpoint determines that procedure P must be aborted and sends an Abort message to a second endpoint carrying the transaction ID for procedure P. The second endpoint then aborts procedure P.

Positioning of devices such as mobile phones has been the subject of vast improvement in the past years. For devices such as smartphones, very accurate positioning is possible when the device is able to receive signals from terrestrial transmitters and non-terrestrial transmitters. However, positioning of persons and objects may be challenging in dense indoor environments, such as stores, warehouses, factories, construction sites, industrial sites, museums, etc.

Some current indoor positioning and sensing techniques fuse information from RF and vision systems but do not use acoustic information or use it in a limited manner. Although positioning using RF and vision systems can provide adequate information in some circumstances, they can have performance challenges, privacy challenges, and may be energy inefficient. Aspects of the current disclosure provide on-demand audio positioning techniques to augment existing positioning systems and, in some cases, to enable device-free positioning of persons and objects.

One challenge with RF systems is positioning accuracy for some currently deployed RF technologies. Electronic Shelf Label (ESL) systems generally use short range BLUETOOTH® Low Energy (BLE) beacons, and have the ability to position items precisely; e.g., with typical positioning accuracy in the range of about a meter. WiFi-based positioning using signal strength measurements such as Received Signal Strength Indicator (RSSI) generally provide significantly coarser position estimates, with uncertainties on the order of several meters. Therefore, WiFi positioning using RSSI is commonly used to locate a general area in which a target asset is located rather than its precise location. WiFi positioning using RTT determinations can provide better positioning accuracy; e.g., of about two meters.

A potential challenge for RF positioning is cost. In some cases, the deployment cost of RF-based technologies constitutes the largest portion of the overall deployment cost. Although ESL systems cost much less on a per-item basis than smartphones, hundreds or even thousands of ESLs may be deployed across shelves and aisles of an Industrial Internet of Things (IIoT) site to provide substantial coverage, requiring a large investment to install. Additionally, ESL systems may use batteries to power the units, requiring maintenance and ongoing battery cost. However, if RF infrastructure is already deployed for an existing system (e.g., a monitoring and surveillance system), the additional cost to implement RF positioning may be limited.

In some cases, vision systems are used to enhance RF capability. Vision-based positioning is extremely accurate, with uncertainties on the order of centimeters for well-characterized targets. However, vision systems are accompanied by another set of challenges; for example, visual occlusions, privacy, energy efficiency, and for hybrid RF and vision-based positioning, difficulty matching the RF positioning information with visual positioning information. Cost may be an issue for sites without deployed vision systems (or when coverage is insufficient for vision-based positioning). However, for sites that already deploy vision infrastructure as part of legacy systems, little or no additional cost for vision-based positioning may accrue. For example, some Over the Top (OTT) infrastructure used for monitoring and surveillance systems includes vision components such as Closed-Circuit Television (CCTV) cameras and audio components such as speakers.

Occlusions can be a particular challenge for indoor sites with dense maze-like aisles and shelves. Large numbers of cameras may be needed for full coverage of the site, and vision-based positioning is limited or unavailable in areas of partial or full visual occlusion. For example, if a target (e.g., customer or worker) that carries an RF device is occluded by shelves or walls, the vision positioning information cannot be extracted from infrastructure vision components (e.g., CCTV vision data/images). Even when a target is equipped with a smartphone that could theoretically be used to provide additional vision positioning information, the camera may be occluded if the device is carried in a pocket or purse, or otherwise positioned so the camera does not provide useful vision information.

Privacy issues may be important in sites subject to privacy rules or regulations, preventing the positioning system from extracting or manipulating any visual features or information beyond identifying regions of interest (RoI) or bounding boxes. In some cases, vision-based positioning may be entirely unavailable due to privacy concerns. For example, a site may prohibit cameras altogether, or a portion of a site may be designated as a restricted area for vision-based positioning (e.g., bathrooms, changing areas, or other private areas).

Energy efficiency is a particular issue for mobile devices not able to access external power when acquiring vision data. For example, a UE camera is commonly the biggest consumer of battery power (usually significantly greater than the RF power consumption), and vision-based positioning can require significant local processing on the UE.

When RF positioning and vision-based positioning are used in a hybrid system, matching vision positioning data with RF positioning data poses another challenge. For example, matching/fusion algorithms that integrate vision and RF data can be hindered by differing uncertainties in different types of RF measurements. An important algorithmic step in RF/vision hybrid positioning is to associate the visually detected objects with the correct target (e.g., person carrying a UE or RF-enabled target asset). Techniques such as multiple target tracking may be used; however, an accurate result may not be obtained when the underlying RF-based positioning information does not meet accuracy thresholds (e.g., in the case of legacy WiFi-RSSI deployments, which provide relatively coarse position estimates).

Aspects of the current disclosure relate to indoor positioning and sensing in challenging environments such as industrial Internet of Things (IoT) environments by enabling activation of audio positioning. For example, audio positioning can be activated in response to one or more criteria, to enable energy efficient and privacy-preserving positioning in indoor environments. The audio positioning can be used with RF-based positioning, vision-based positioning, or a combination thereof in a hybrid positioning technique.

Audio-based positioning can provide additional degrees of freedom and help mitigate some issues in current systems, while providing a reliable always-on hybrid positioning solution. In some aspects, the techniques are energy efficient and provide enhanced privacy by integrating position-related information from audio signals generated and sensed using audio systems in infrastructure and devices associated with assets and people. Note that the terms “acoustic” and “audio” are used herein to refer generally to sound-based signaling and detection, whether the frequency is in the audible range or not.

Audio-based positioning techniques use soundwaves; for example, with a frequency range between about 15 kHz and 25 kHz. Using frequencies at the high end of the audible range and extending just above can allow the use of devices with microphones and speakers that can sense/generate soundwaves with frequencies in the audible range without modification. For example, infrastructure audio components and UEs with integrated microphone(s) and speaker(s) can process/generate sound signals in a frequency range extending above the hearable range if the sampling frequency, frequency selectivity, etc. are within the existing audio processing capability of the device. Therefore, in some cases an audio positioning system can be deployed with little or no hardware modification or additional hardware installation.

Audio-based positioning can include range-based and device-free techniques. Range-based techniques can use indications of range such as Time of Flight (ToF), Time Difference of Arrival (TDoA), and Round Trip Time (RTT) techniques. Some device-free audio positioning techniques (described in more detail below) use round trip time-of-flight of audio signals. For example, information for transmitted audio signals and for detected reflections are used to determine a ToF, which indicates a range to the object.

Audio-based positioning can use a number of signaling protocols. For example, orthogonal frequency division techniques, frequency hopping techniques, and orthogonal time division and coding protocols may be used with audio signaling.

Accuracy of audio positioning depends on the environment and the implemented technique. For example, an indoor range-based audio positioning system that uses RTT or ToF ranging techniques can provide positioning accuracy in the range of one to three meters of accuracy at 80%-90%, which is comparable with WiFi-RTT and ESL-BLE based positioning systems.

Some relative range-based techniques use Doppler effect and phase shift of audio signals. For example, relative range-based audio positioning systems have found success in gesture tracking (i.e., tracking of bodily parts such as hand, fingers as well as their interactions with electronic devices). Reported accuracies for gesture tracking systems are on the order of centimeters.

Audio-based positioning may present a variety of challenges. For example, sound waves and audio processing may both present latency and delay challenges. Sound waves propagate much more slowly than RF, and propagation speed is subject to variation based on environmental factors to a much greater extent (although strict environmental control can mitigate at least some of the variation). In another example, audio positioning may not be energy efficient when performed by a device powered by a battery; for example, a smartphone or other UE, especially when the device is in use for purposes other than positioning.

Audio-based positioning may also present a variety of advantages. For example, in an environment including legacy audio infrastructure (such as a legacy monitoring and surveillance system), additional infrastructure cost may be minimal. Additionally, most modern UEs are equipped with speakers and microphones (as well as audio processing circuitry), incurring no additional deployment cost on the end device. As noted above, audio circuitry in existing infrastructure audio components and in UEs may be capable of generating and detecting audio signals near and above the top of the hearable frequency range without modification.

Audio-based positioning may also present a performance advantage compared with some other positioning technologies. For example, audio positioning can offer more reliable accuracy than some RF-based approaches (such as WiFi-RSSI for instance), depending on the deployment. As noted above, audio positioning that uses RTT or Time-of-Flight ranging techniques (e.g., Audio-RTT) can offer positioning error comparable to ESL-BLE and WiFi-RTT (in the range of one to three meters of accuracy at 80%-90%).

One important advantage of audio positioning compared to vision-based positioning is privacy. This can be a particular advantage in sensitive environments, where vision-based positioning is unavailable in at least some areas.

According to some aspects, a hybrid positioning system includes audio positioning, along with vision-based positioning, RF-based positioning, or both. For example, in response to one or more criteria, a network entity may determine to activate (or deactivate) audio positioning. The criteria can be selected based on the particular implementation, to balance energy efficiency, accuracy, privacy, and other factors according to the priorities of the implementation. More information about example criteria is outlined below. Depending on the circumstances, the system may be implemented to use existing infrastructure without interfering with the operation of legacy systems (e.g., monitoring and surveillance systems).

Aspects of the disclosure can address various situations that might arise in Industrial IoT setups (such as retail stores, etc.) with respect to positioning performance, system failures, privacy and system restrictions which pose challenges to RF-based positioning and vision-based positioning. The techniques can be used for reliable positioning in an energy efficient manner, while balancing delay/latency, privacy, and accuracy. In some aspects, audio positioning can be used for hybrid positioning when RF positioning accuracy/RF signaling is not sufficient to match RF devices with visual detections.

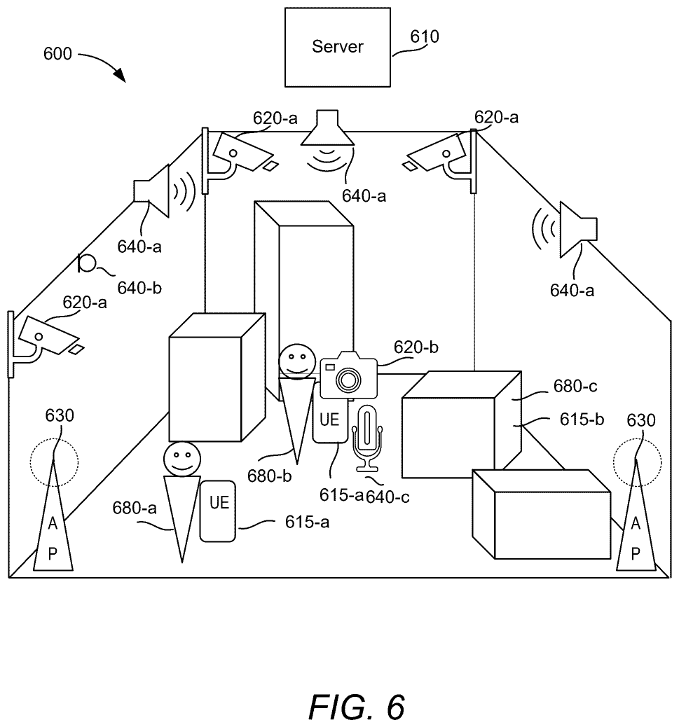

FIG. 6 shows an example environment 600 in which RF, vision, and/or audio positioning can be deployed, according to some aspects of the disclosure. A plurality of targets 680 such as customers, workers, assets, or a combination thereof are distributed in environment 600. In some aspects, targets 680 can each be associated with an RF device such as a UE 615, so a position estimate of a UE 615 can be used as the position estimate for the associated target 680. Targets 680 can be positioned using RF, vision, and audio components integrated with UE 615 or connected to UE 615 (e.g., BLUETOOTH® or WiFi accessories), and using infrastructure RF, vision, and audio components. Infrastructure RF components can include Electronic Shelf Label Bluetooth Low Energy (ESL-BLE) devices, Radio Frequency Identification (RFID) readers and tags, and/or other infrastructure RF devices. Infrastructure vision components 620 can include shelf cameras or Closed-Circuit Television (CCTV) cameras 620-a, and/or other infrastructure cameras. Infrastructure audio components 640 can include wall- or shelf-mounted speakers 640-a, wall-mounted or shelf-mounted microphones 640-b, and/or other infrastructure audio devices.

A network entity such as a server 610 includes memory and processor circuitry to implement the techniques described herein. In some examples, in addition to implementing the techniques herein, server 610 may also manage algorithms for a monitoring and surveillance system (or other legacy system) to provide additional functionality at the site. In some aspects of the disclosure, server 610 can host most or all of the algorithms (processing, positioning), maintain connections with UEs 615 over the RF interfaces, and maintain connection to the OTT infrastructure (e.g., maintaining control access to the OTT-vision system of surveillance cameras and the OTT-audio system of speakers).

One technique to locate persons and items in the space is using RF components of UE 615, including RF components of devices such as smartphones, as well as passive and active Radio Frequency Identification (RFID), special use RF devices, etc. In some aspects, the RF devices may be carried by a person or fixed to an asset. For example, customers 680-a may use a proprietary application on a user equipment (UE) 615-a such as a smartphone to navigate the site, and employees 680-b may use RFID reader to sense RFID tag 615-b to locate assets such as RFID-tagged asset 680-c. Electromechanical smart devices such as robots, automated guided vehicles, smart carts, and the like may use one or more RF technologies to navigate the space to find, place, or retrieve assets using on-board RF capability. In some implementations, each target 680 is associated with an RF device such as a UE 615, configured to communicate with one or more devices of an RF infrastructure such as access points 630. UE 615 need not be a sophisticated device like a smartphone; in some aspects UE 615 may be an RF-capable device associated with a target 680 that can communicate with infrastructure devices using a short range RF protocol. The communication may use protocols such as WiFi, Electronic Shelf Label Bluetooth Low Energy (ESL-BLE), RFID, etc. In some implementations, UEs 615 maintain connection with server 610 across one or multiple RF modalities and technologies (e.g., WiFi-RSSI, WiFi-RTT, ESL-BLE etc.), and measures/reports position-related information. UEs 615 also communicate with server 610 to receive audio protocol information, instructions and commands from server 610 and to transmit audio measurements and reports back to server 610.

Access points 630 and other components in environment 600 may be in communication with server 610, using wired and/or wireless interface. Server 610 may manage positioning for environment 600, according to aspects of the current disclosure.

In an example, a UEs 615 in environment 600 communicates with server 610 via access points 630. UE 615-a can detect signals to implement RF-based positioning techniques such as WiFi-RSSI, WiFi-RTT, ESL-BLE, etc. UE 615-a can report measurements and other positioning related parameters to server 610. UE 615-a can also obtain audio protocol information from server 610, such as configuration information, and/or other instructions or commands. UE 615-a can also transmit audio measurements and reports to server 610.

Vision systems may provide another modality to locate and interact with people and items in environment 600. For example, environment 600 may include vision components 620, such as closed circuit television (CCTV) cameras 620-a, shelf cameras, or other types of infrastructure cameras. Vision components 620 can also include one or more user cameras such as a handheld camera 620-b and/or one or more cameras integrated with UEs 615. In some cases, infrastructure cameras may be used for a monitoring and surveillance system in addition to enabling vision-based positioning. For example, vision components may include a network of CCTV cameras 620-a installed as part of a monitoring and surveillance infrastructure. When used for monitoring and surveillance, they may be predominantly static and passive nodes that collect security footage from the area which can then be used for vision-based positioning.

Audio systems may provide another modality to locate and interact with people and items in environment 600. For example, environment 600 may include audio components 640 including one or more speakers 640-a (audio transmitters) and microphones 640-b (audio receivers). In some implementations, infrastructure speakers 640-a and microphones 640-b may be deployed as part of a monitoring and surveillance system. UEs 615 may include integrated speakers 640-a and microphones 640-b. In some aspects, infrastructure speakers 640-a transmit audio signals and microphones 640-b integrated with UEs 615 perform audio positioning. Infrastructure audio components 640 communicate with server 610 through a wired or wireless connection, while user audio components 640 may communicate with server 610 using an RF interface, or by interacting with infrastructure audio components 640 using an audio interface.

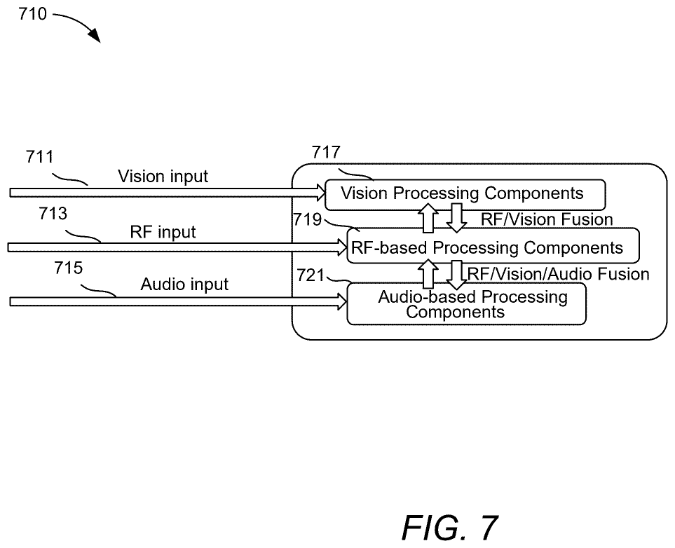

FIG. 7 illustrates functionality of a hybrid positioning engine 710, which may be implemented in a network entity such as server 610 of FIG. 6. Hybrid positioning engine 710 may be implemented with circuitry such as that shown in FIG. 3C, where the positioning components include vision processing components, RF-based processing components, and audio processing components.

Referring to FIGS. 6 and 7, hybrid positioning engine 710 receives vision input 711, RF input 713, and audio input 715 obtained by infrastructure and user RF, audio, and vision components. Hybrid positioning engine 710 further includes vision processing components 717, RF processing components 719, and audio processing components 721.

According to some aspects, vision input 711 can be obtained from CCTV cameras 620-a, shelf cameras, handheld cameras 620-b, and cameras integrated with UEs 615, and provided to vision processing components 717. The RF input 713 can be obtained from UEs 615, ESL-BLE devices, and other RF devices of environment 600, and provided to RF processing components 719. If audio processing is not currently activated, hybrid positioning engine 710 can execute an RF/vision fusing algorithm to position one or more UEs 615/targets 680 based on the visual and RF inputs. The RF/vision fusing algorithm matches the vision input with corresponding RF input, and uses a fusion of the input to estimate target position.

When audio components are activated, audio input 715 can be obtained from infrastructure and user speakers 640-a, infrastructure and user microphones 640-b, as well as speakers and microphones integrated with UEs 615 and provided to audio processing components 721. If both RF and vision based positioning are active, hybrid positioning engine 710 can execute an RF/Vision/audio fusion algorithm, matching inputs from all three modalities to estimate UE/target position. If one or the other of RF or vision based positioning are not active, a fusion algorithm can match data from the active input with audio input, to estimate a position of the target object. Example criteria for activating audio positioning are described in more detail below.

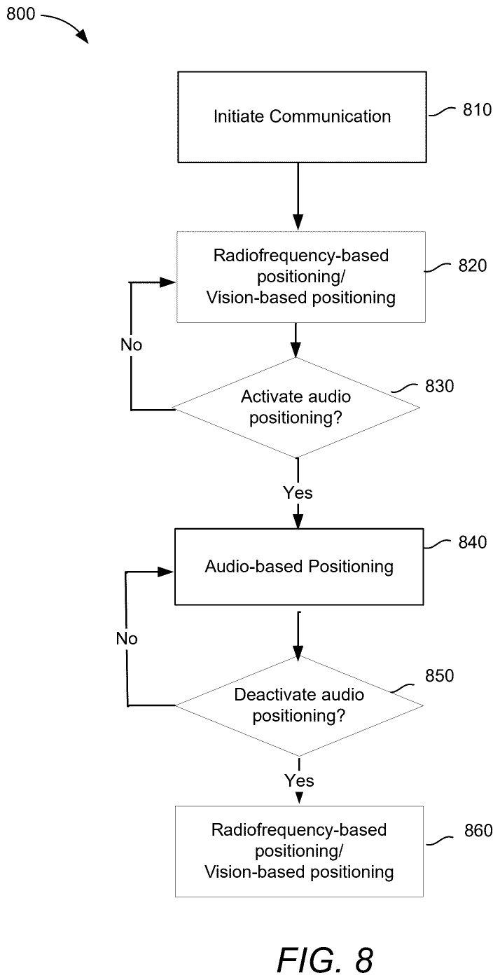

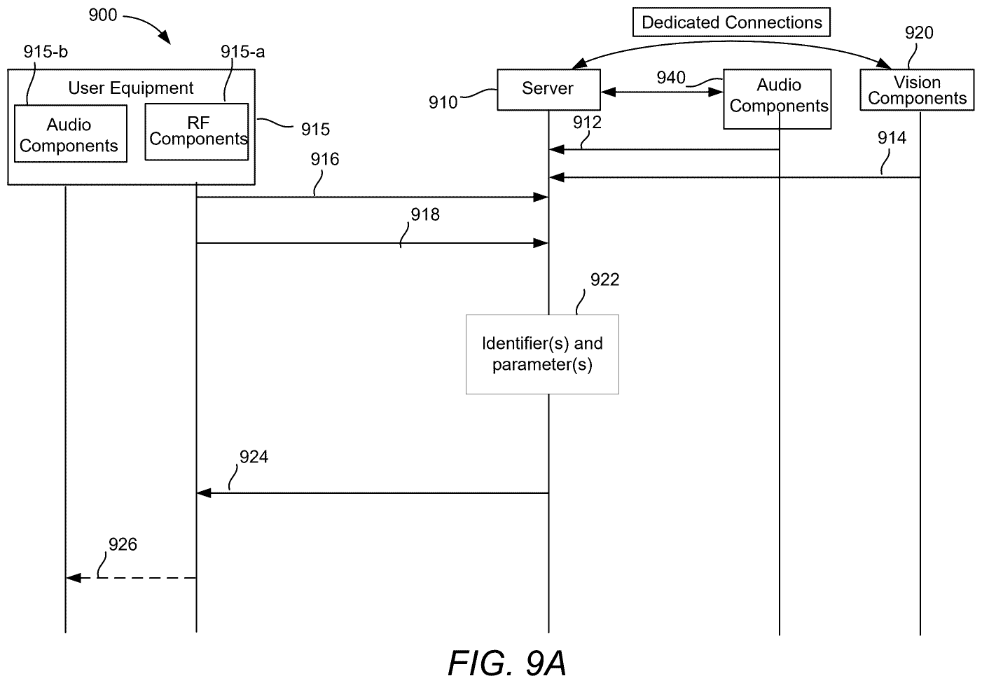

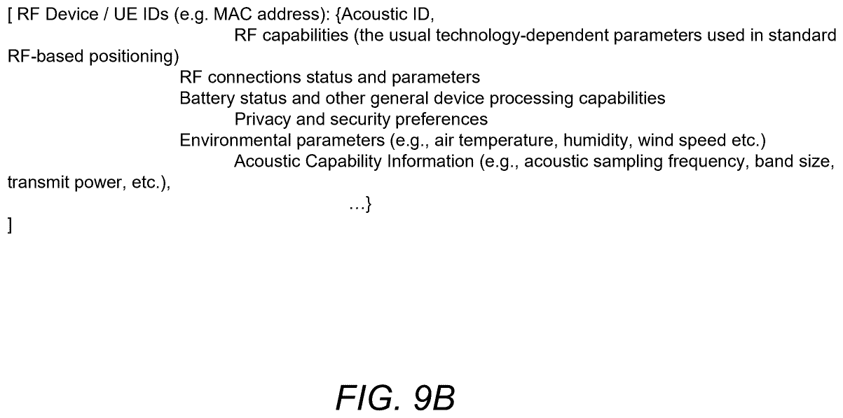

FIG. 8 shows an example positioning method 800, according to some aspects of the disclosure. At 810, a UE and a network entity such as a server initiate communication; for example, in response to the UE entering the site. An example initialization process is illustrated in FIG. 9A and described below.

At 820, the server may use RF-based positioning and/or vision-based positioning to estimate a position of the UE. RF-based positioning may use techniques such as WiFi-RTT, WiFi-RSSI positioning, positioning based on ESL-BLE deployments, and/or other RF-based techniques to acquire RF positioning information. Vision-based positioning techniques can use infrastructure cameras such as CCTV cameras and shelf cameras, and/or user cameras to obtain vision positioning information. In a hybrid technique, visually detected objects are associated with the correct RF device; for example, using multiple target tracking. For example, RF-based positioning can be used to estimate a position of the UE, and vision positioning data from one or more cameras can be obtained using the estimated position.

At 830, the server and/or UE can detect one or more criteria to determine whether to activate audio positioning. The one or more criteria may include RF-based criteria (e.g., an indication of RF signal quality), vision based criteria (e.g., indication of partially or fully occluded area, indication of a vision restricted area), and criteria that can combine RF-based criteria and vision based criteria such as positioning performance criteria (e.g., one or more position quality metrics such as a confidence or error parameter for a position estimate based at least partially on RF and/or vision measurements), etc.

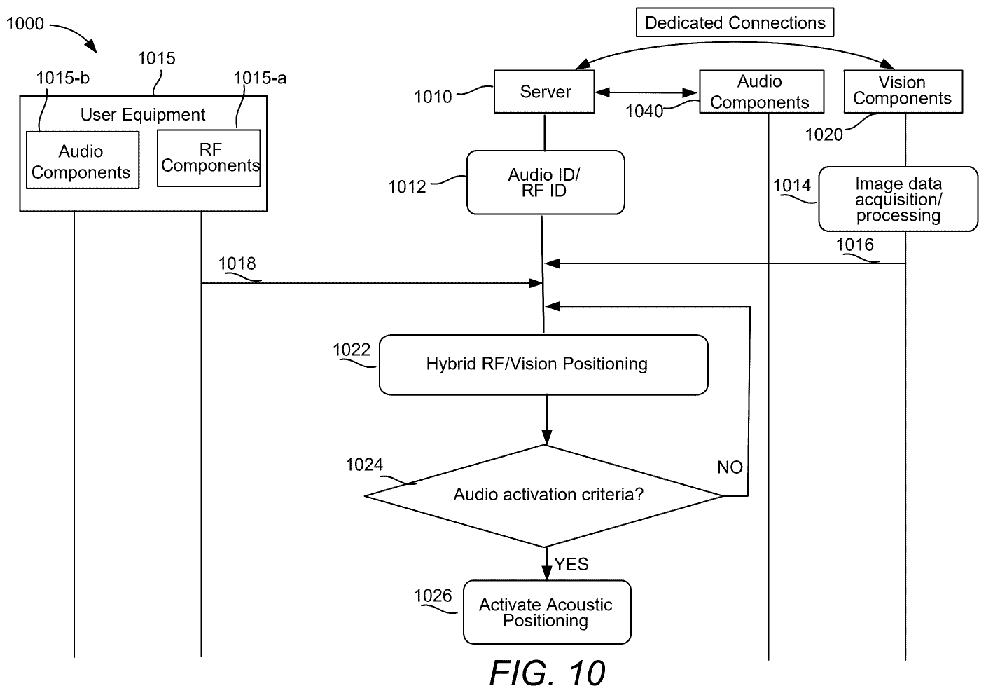

For example, key indicators such as positioning performance, RF signal quality indicators, restricted area access, etc. can be monitored in an ongoing manner. RF and/or vision-based positioning continues until one or more criteria are detected to initiate audio positioning. For example, if one or more key indicators cross prespecified thresholds, the server may activate audio processing and positioning. FIG. 10 illustrates an example process for activating audio positioning in response to one or more detected criteria, according to some aspects of the disclosure.

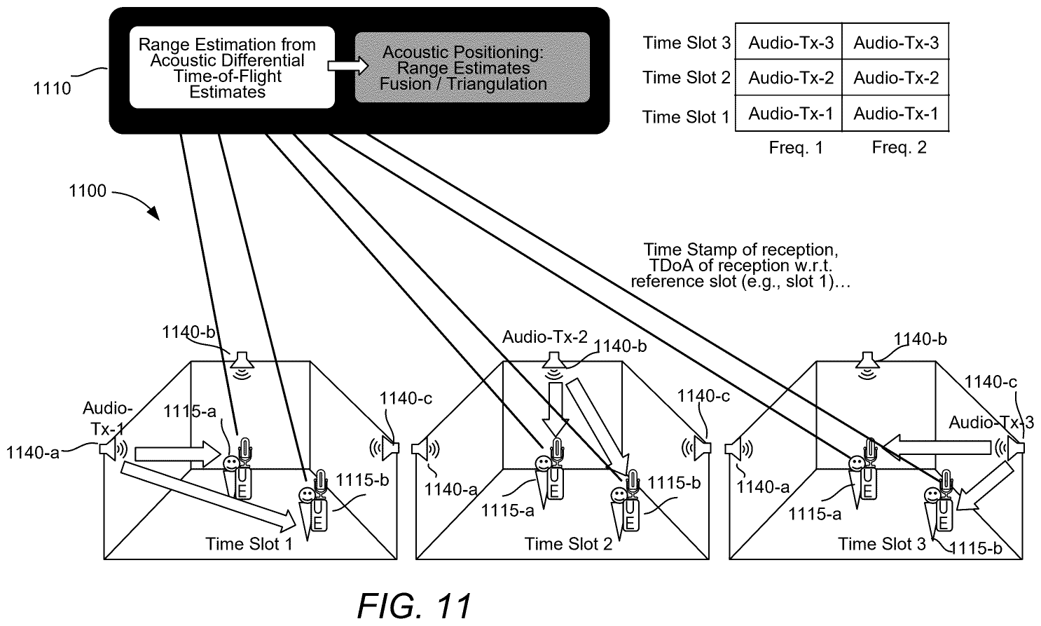

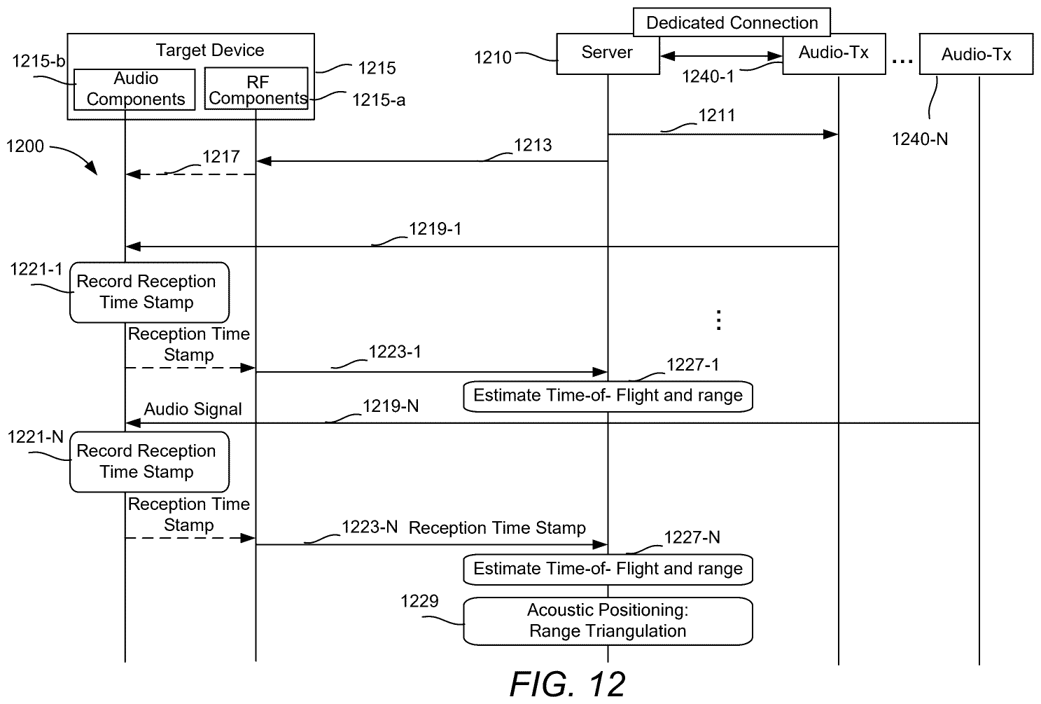

At 840, in response to detection of one or more criteria to initiate audio positioning, one or more audio positioning techniques are performed. FIG. 11 illustrates audio signaling configuration and measurements, according to some aspects of the disclosure. FIG. 12 illustrates an example process of audio positioning, according to some aspects of the disclosure.

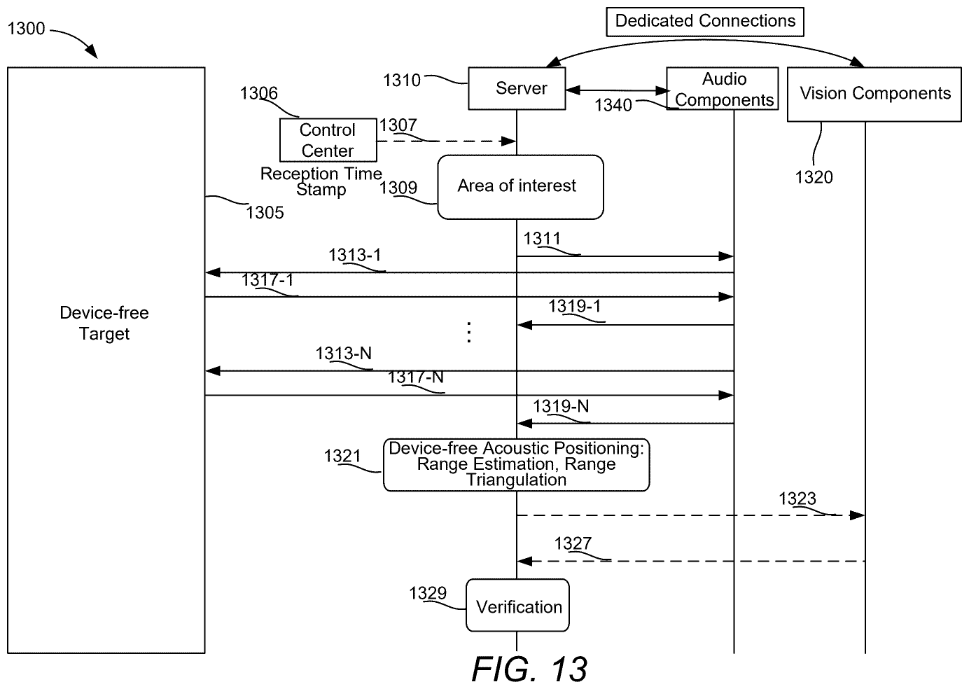

In another example, the one or more criteria indicate that device-free audio positioning should be performed. FIG. 13 illustrates an example process for device-free audio positioning, according to some aspects of the disclosure.

Audio-based positioning can be performed until an indication to deactivate audio positioning is detected at 850. For example, the server/UE may continue to monitor indicators such as positioning performance, RF signal quality indicators, and restricted area access, and deactivate audio positioning when the indicators cross a threshold indicating audio positioning should be deactivated. At 860, RF-based positioning and/or vision-based positioning can be used for position estimation, until the positioning is complete (e.g., a user exits the site), or until audio positioning is indicated again.

FIG. 9A shows an example initialization method 900, according to some aspects of the disclosure. Initialization may be an important supporting function for hybrid positioning including at least some audio positioning.

Server 910 may have dedicated connections to infrastructure vision components 920 (e.g., CCTV cameras, shelf cameras, etc.) and infrastructure audio components 940 (e.g., speakers and microphones). Audio components 940 may transmit audio connection information and audio data to server 910 at 912. Video components 920 may transmit vision connection information and vision data to server 910 at 914. Connection information and data may be provided to server 910 in an ongoing manner; for example, according to a schedule, in response to events, according to one or more criteria, etc. In some cases, a legacy system such as a monitoring and surveillance system may be requesting and receiving audio data, vision data, or a combination thereof in parallel with the operation of the positioning techniques disclosed herein.

At 916, UE 915 transmits an initial access request to server 910 using RF components 915-a. At 918, UE 915 transmits additional device and RF parameters to server 910. The initial access request can be included in the same message as the device and RF parameters, or separately. Server 910 may also obtain additional synchronization information for an audio positioning protocol (if not already provided through the RF connection establishment). Example information included in connection establishment messaging and device and RF parameter messaging can include a UE/device battery status, device connectivity status, device audio processing and audio capabilities, audio positioning capability, device privacy preferences, environmental parameters, etc.

Device connectivity status may indicate whether the UE/device is on an active call or otherwise in use (and possibly being held in a user's hand), or is inactive and likely in a pocket or purse. Device audio processing and audio capabilities can include audio sampling frequency capability, audio bandwidth range capability, microphone transmission capabilities such as maximum transmission power), supported audio protocols (audio protocol capability), etc.

Device privacy preferences may be provided by a user via an application, web site, or other manner; for example, selected through an application or web site associated with the store or other site. Privacy preferences may include audio privacy preferences such as an indication of whether the user consents to providing audio information in response to a server request (“opt-in”), as well as the user's preferences for other privacy-related information (e.g., privacy aspects related to the visual processing).

Environmental parameters can include parameters such as air temperature and humidity that can affect sound propagation. The environmental parameters can be used to control environmental conditions at the site and/or to calibrate audio measurements.

Once the initial RF connectivity is established and audio capabilities of the device determined, the server may assign a unique audio identifier to each device at 922 and associate the audio identifier with a device/UE identifier such as a MAC address, provided by the UE during initialization.

The audio ID can be mapped to specific audio protocol information used for the audio positioning protocol (e.g., audio access and protocol parameters, synchronization, etc.). In some cases, the audio protocol information includes a unique sound frequency (tone) or frequency range, a frequency hopping pattern, etc. The audio positioning protocol information/configuration may be determined upon activation of audio positioning, or at least some may be determined at a different time. For example, a server can configure audio time and frequency resources for an audio positioning protocol once audio positioning is activated.

The server may maintain a database of active UEs, with device parameters, audio parameters, etc., associated with one or more UE identifiers. An example database format is illustrated in FIG. 9B; however, different formats, identifiers, and parameters may be used, depending on the implementation.

At 924 the server may transmit the audio identifier and/or other parameters to UE 915; for example, to RF components 915-a which can provide at least some of the parameters to audio components 915-b at 926.

FIG. 10 illustrates an example process 1000 for activating audio positioning in response to one or more detected criteria, according to aspects of the disclosure. Aspects of process 1000 can provide energy-efficient, latency-aware and privacy-preserving positioning performance. UE 1015 can include RF and audio processing components and well as vision-based components (e.g., for a camera integrated with UE 1015 or in communication with UE 1015 over a short-range wireless connection). Server 1010 can also include vision processing components, RF processing components, and audio processing components, as shown in FIG. 7 (with reference to FIG. 3C) and described above. Vision processing components process vision positioning information (such as processed image data or unprocessed image data), while RF processing components process RF positioning information (RF signal measurements and/or detections), and audio processing components process audio-based positioning information (such as audio measurements and/or detections).

Server 1010 may have dedicated connections to infrastructure vision components 1020 (e.g., CCTV cameras, shelf cameras, etc.) and audio components 1040 (e.g., infrastructure speakers and microphones). Server 1010 prioritizes maintaining an RF connection with UE 1015 for communication and positioning, as well as other signaling purposes. Since UE 1015 has a finite battery, an integrated camera may be given low priority for positioning and sensing, and on-board processing can be managed for energy efficiency and low latency. In some implementations, use of a handheld camera may be limited to specific circumstances (e.g., security threats), if the battery status permits such use.

Server 1010 and UE 1015 perform initialization; for example, as shown in FIG. 9A and discussed above. For example, at 1012, server 1010 associates an audio identifier with a UE identifier and stores the information in (for example) a database.

Prior to activation of audio components 1040, positioning may be performed using vision data and/or RF data. For example, vision components 1020 obtain image data and optionally perform at least some processing at 1014, and transmit image data and/or processed image data to server 1010 at 1016. At 1018, UE 1015 transmits RF measurements and reports to server 1010. The measurements and reports can include RF positioning information and measurements indicating RF signal quality or other parameters that may indicate potential issues with RF measurements.

At 1022, server 1010 processes RF and vision information and performs hybrid RF-vision positioning. In some aspects, hybrid RF-vision positioning includes matching RF and vision data to estimate a position of UE 1015. Server 1010 may compute confidence metric(s) and/or other quality measures as part of the hybrid RF-vision processing.

At 1024, server 1010 determines whether to activate audio processing. For example, server 1010 and/or UE 1015 monitor key indicators such as positioning performance, RF signal quality indicators, and restricted area access to determine whether one or more criteria are met. Examples of RF-based and/or vision based criteria include: one or more positioning performance criteria, one or more RF signal quality criteria, and one or more user location criteria. If no criterion is detected, server 1010 and UE 1015 continue to perform RF-based positioning and/or vision-based positioning.

Positioning performance criteria can be detected based on RF-based positioning and/or vision-based positioning parameters. For example, server 1010 can obtain and use RF reports, as well as vision information from infrastructure cameras such as CCTV Cameras (e.g., visual detections, bounding boxes) to obtain target position estimates. Each position estimate is associated with certain confidence (e.g., confidence associated with position estimates determined within a Bayesian estimation framework). One or more thresholds may be defined indicating a positioning quality below which audio positioning is activated; for example, one or more thresholds of positioning confidence. Poor quality positioning may be due to a number of factors, such as RF channel quality deterioration due to fading, visual occlusions (complete or partial), loss of connection to high-performance network and handover to default network (e.g., from ESL-BLE to WiFi-RSSI), etc.

RF signal quality criteria may be based on one or more RF connection parameters; for example, signal to noise ratio (SNR), channel quality indicators, etc. If the RF signal quality is significantly degraded, it can be difficult for hybrid positioning algorithms to reliably match RF position information with visual detection. In another example, when both vision-based positioning and RF-based positioning are relatively poor quality, audio positioning may be activated to improve accuracy. For example, RF-based position estimates may be used to coarsely determine the target position (e.g., what general area), and then activation of audio positioning can engage a subset of nearby speakers (audio-transmitters) to perform positioning without undue latency.

User location criteria may be based on certain areas within a site being designated as restricted for vision-related positioning (e.g., bathrooms or other private areas) and/or where RF signals are restricted or unavailable for other reasons (e.g., poor coverage by design). In some aspects, an indication to activate audio positioning based on user location criteria may be based on determining that a user is within a threshold distance of a border of a particular region.

In some cases, device-free audio positioning may be activated in response to a trigger condition (one or more conditions or acts). For example, audio positioning may be activated in response to determining that a UE has not been responsive to communications for a threshold time (e.g., an indication that the battery has become depleted). Other examples include alerts for safety reasons; e.g., a lost child or other person, a lost asset, as well as alarm-raising security threats (e.g., intrusion of a trespasser). Device-free audio positioning may also be activated to position a customer in need of assistance without a device; for example, an elderly customer.

At 1026, in response to detecting one or more criteria, server 1010 may activate audio positioning. Server 1010 may provide at least some audio positioning configuration to UE 1015 prior to the activation, or may provide audio positioning configuration to UE 1015 based on the activation.

A number of different audio positioning protocols can be configured and used, with frequencies at/just above the audible sound frequency domain, according to aspects of the disclosure. According to aspects of the disclosure, audio protocols can be selected to separate UE signaling orthogonally, while maintaining a manageable delay profile with relatively low synchronization-based issues. A network entity such as a server can configure audio frequency resources and audio time resources to one or more UEs and/or one or more infrastructure devices for audio signaling. For example, a server can configure different UEs with different frequency resources (e.g., frequency resources for one or more sound tones, frequency resources for frequency hopping, etc.), different time resources (e.g., time resources for one or more time slots/time ranges), etc., to enable orthogonal communication and avoid or mitigate interference.

According to some aspects of the disclosure, a network entity such as a server can implement a centralized scheduling scheme to manage signaling and synchronization information. According to a first example, the sound spectrum and time domain can be organized into a time-frequency grid divided into frequency bins/carriers and time slots.

In another example, orthogonalization in the frequency-domain with a time-division signaling scheme can be used, as shown in FIG. 11 and described below. A unique tone is assigned to each microphone (audio receiver) by the server; this tone is then used by the speakers (audio transmitters) in a time-multiplexed manner to send positioning beacons to the microphones.

In another example, orthogonalization in the code domain via frequency hopping can be used; for example, to accommodate larger number of devices across a limited sound spectrum (e.g., due to end-devices sampling rate limitations). In some cases, standard frequency hopping may be used via unique orthogonal sequences which are assigned to each microphone (audio receiver).

The size of the used spectrum, the number of tones, the transmission power, the duration of the time slot, and/or other parameters can be selected according to the particular implementation. For example, the parameters can be selected to provide energy efficient performance with acceptable latency for the system.

FIG. 11 illustrates an audio positioning configuration and measurement system 1100, according to some aspects of the disclosure. Audio-based signaling can suffer from interference, which can be severe. In order to mitigate interference and enable energy-efficient design with reduced latency, a number of sound tones (audio frequencies at or above the hearable range) can be defined and allocated among devices and/or transmissions; for example, using the protocols discussed above, and audio positioning techniques such as ToF, TDoA, and RTT.

In FIG. 11, a first UE 1115-a is associated with a first user, and a second UE 1115-b is associated with a second user. In order to position both users without detrimental interference between audio signaling, first UE 1115-a receives configuration to perform audio positioning using an ultrasound tone at a frequency f₁, using time resources including time slots 1-3, while second UE 1115-b receives configuration to perform audio positioning using an ultrasound tone at a frequency f₂, also using time resources including time slots 1-3.

Infrastructure speakers 1140-a, 1140-b, and 1140-c are configured to transmit downlink sound beacons (audio signals at frequencies f₁ and f₂) during time slots 1-3, which are received by microphones integrated with UEs 1115-a and 1115-b. UEs 1115-a and 1115-b can determine a time difference of arrival (TDoA) across speakers, and transmit information related to detection of the received signals to a server 1110 for processing. Depending on the UE capability and circumstances, a UE can estimate its own position using the audio information (in this example, TDoA information), or can send the audio information to server 1110 to estimate the UE position. In general, the audio information can include measurement information such as audio signal power measurement information, audio signal direction measurement information, audio signal phase measurement information, audio time of receipt measurement information, audio time difference of arrival measurement information, or a combination thereof.

For an implementation in which global synchronization between speakers and microphones is substantially maintained, the UEs may only send the time stamp of the reception of the sound tone. For example, UEs 1115-a and 1115-b can time stamp the detected signals with a Time Difference of Arrival with respect to a reference slot (e.g., time slot 1).

In another aspect, a round trip time (RTT) audio protocol can be used. For example, speakers 1140-a, 1140-b, and 1140-c transmit downlink sound beacons according to the audio configuration and the microphones integrated with UEs 1115-a and 1115-b receive them and then transmit uplink sound beacons (e.g., frequency tones using time-division multiple access). Microphones co-located with speakers or located elsewhere at the site receive the uplink sound beacons, and transmit the audio information to server 1110 to determine a round trip time, which is used for a position estimate. According to aspects of the disclosure, server 1110 uses the audio positioning information in a hybrid positioning process; for example, using audio positioning information with RF positioning information, vision positioning information, or both. Note that RF positioning information, vision positioning information, or both can have other purposes; for example, monitoring and surveillance systems.

FIG. 12 shows an example method 1200 of performing audio positioning for the example technique where infrastructure and user audio devices are substantially synchronized, according to some aspects of the disclosure. A server 1210 can activate audio positioning in response to one or more criteria (e.g., one or more of the criteria listed above). Server 1210 can distribute audio protocol parameters at 1211; for example, transmitting information for time and/or frequency resources, protocol identification, etc. to infrastructure audio devices 1240-1 to 1240-N (e.g., N audio-transmit speakers).

At 1213, server 1210 can message RF components 1215-a of UE 1215 to activate audio components 1215-b for audio processing, according to the audio protocol. The messaging may also configure a specific frequency sweeping pattern as well as other key audio processing parameters such as timing of transmissions, slots, etc. For example, at 1217, one or more microphones integrated with or in communication with UE 1215 (audio-receive microphones) can be configured to receive audio signals from speakers 1240-1 to 1240-N.

To perform the audio positioning, infrastructure audio devices 1240-1 to 1240-N can transmit signals according using orthogonal resources (e.g., time division multiplexed or frequency division multiplexed resources). For example, at 1219-1, device 1240-1 can transmit downlink audio signals (e.g., an audio signal with a first frequency), which are detected by audio components 1215-b of UE 1215, and at 1221-1 a timestamp is generated by the audio components and/or other components of UE 1215. At 1223-1, the timestamp is provided to RF components 1215-a of UE 1215, which transmits them to server 1210 at 1223-1. Server 1210 estimates a Time of Flight range at 1227-1 based on the timestamp (and the known position of audio device 1240-1).

The process repeats for the N infrastructure audio devices, according to the assigned time resources, at 1219-N, 1221-N, 1223-N, and 1227-N. At 1229, server 1210 estimates the position of UE 1215, using triangulation/multilateration of the estimated ToF/range values.

As noted above, device-free audio positioning may be performed in response to one or more trigger conditions. For example, audio positioning may be activated to position a UE that had been actively positioning a target but has not been responsive to communications (e.g., the battery has become depleted). Other examples include alerts for safety reasons; e.g., a lost child or other person, a lost asset, as well as alarm-raising security threats (e.g., intrusion of a trespasser).

It can be challenging to locate a device-free target using standard technologies such as RF based on WiFi or ESL-BLE beacons. Vision-based positioning may be used if sufficient coverage of the region is available; however if the device-free target is in an occluded region, vision-based positioning will not be able to position the target. This may be more common in dense, maze-like interior spaces. In some current systems, device-free audio positioning finds applications in gesture tracking and other close-range application where the speaker is in proximity of the target which still operating in the same frequency range (although higher frequency ranges may be considered as in ultrasound technology for instance).

FIG. 13 illustrates an example method 1300 of device-free positioning incorporation audio positioning techniques, according to some aspects of the disclosure. According to some aspects of the disclosure, device-free positioning uses sound scanning in the frequency range near or above the top of hearable range. Audio transmitters 1340 (e.g., infrastructure speakers, speakers from cooperating UEs, and/or other on-site audio devices) transmit sound patterns and audio receivers (e.g., infrastructure microphones, microphones from cooperating UEs, and/or other on-site audio devices) detect the echo. In an example, speakers and microphones may be densely deployed on shelves (e.g., as part of an ESL-BLE system), and the audio positioning is based on short range transmission and reception. In some cases, infrastructure audio components may be strategically placed to provide coverage in areas that may be vision-occluded. For example, speakers may be placed on the side of shelves with shelf cameras for some ESL-BLE deployments.

Device-free positioning may be managed by a control center 1306, which can be integrated with a network entity such as a server 1310, or may be implemented separately. Control center 1306 may receive information about a trigger condition for device-free audio positioning of a target. The trigger condition may be an alarm for a security condition like a lost child or the detection of a trespasser, may be a customer service trigger condition like an indication that an elderly person needs assistance, or may be a device-related trigger condition, like an indication that a UE that had been in communication with server 1310 had not communicated for a threshold time period.

In response to a trigger condition for device-free positioning, control center 1306 may transmit a time-stamped alarm signal 1307 to server 1310. At 1309, server 1310 may determine an area of interest of relevant device-free target 1305. In some cases, the entire site may be the area of interest, while in others the area of interest may be a portion of the site (e.g., near the last sighting of a lost child, near the area in which a battery-depleted device had most recently been located, etc.). In an example, an area of interest can be based on a prediction of target location based on prior history just before a most recent RF report or employee alarm.

At 1311, server 1310 activates relevant audio components 1320 (e.g., audio transmitters). The pool of relevant audio components 1320 may include audio transmitters included in cooperating end devices, such as UEs and other devices that can generate and/or detect audio signals and which may be located proximate the target.

Server 1310 may provide an indication of the area of interest, configuration for an audio positioning protocol, and/or other information. At 1313, audio components 1340 can generate audio signals to scan the area of interest following a specified transmission protocol (e.g., time division, one-at-a-time). In some aspects, audio components 1340 transmit an audio pattern at 1313-1, including sound tones across an audio spectrum, and measure the corresponding echo at 1317-1. At 1319-1, audio components 1340 transmit echo information to server 1310, which can compute a range to the target object.

In FIG. 13, the process is repeated N times, at 1313-N, 1317-N, and 1319-N. In some aspects, server 1310 determines the number of repetitions for accurate positioning of device-free target 1305. At 1321, server 1310 estimates the position of target device 1305 using estimated ranges and triangulation/multilateration.

In some cases, there may be multiple possible detections/candidates. Server 1310 may use information for other active devices in the area to eliminate non-relevant candidates. For example, at 1323, server 1310 may ping/activate infrastructure cameras, if available, and receive the camera output at 1327 to eliminate other candidates (or to refine the location of target 1305) at 1329.

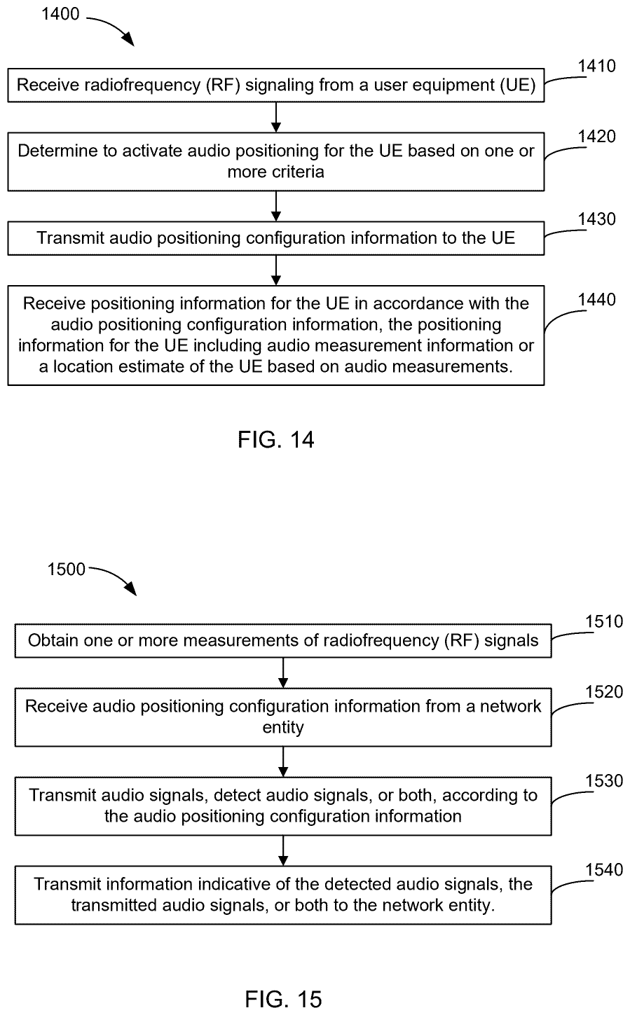

FIG. 14 illustrates an example method 1400 of communication, according to aspects of the disclosure. In an aspect, method 1400 may be performed by a network entity (e.g., any of the network entities described herein).

At 1410, a network entity such as a server receives radiofrequency (RF) signaling from a user equipment (UE). In an aspect, where the network entity is a server, operation 1410 may be performed by the one or more network transceivers 390, the one or more processors 394, memory 396, and/or positioning component(s) 398, any or all of which may be considered means (structure) for performing this operation.

At 1420, the network entity determines to activate audio positioning for the UE based on one or more criteria. In an aspect, where the network entity is a server, operation 1420 may be performed by the one or more network transceivers 390, the one or more processors 394, memory 396, and/or positioning component(s) 398, any or all of which may be considered means (structure) for performing this operation.

At 1430, the network entity transmits audio positioning configuration information to the UE. In an aspect, where the network entity is a server, operation 1430 may be performed by the one or more network transceivers 390, the one or more processors 394, memory 396, and/or positioning component(s) 398, any or all of which may be considered means (structure) for performing this operation.

At 1440, the network entity receives positioning information for the UE in accordance with the audio positioning configuration information, the positioning information for the UE including audio measurement information or a location estimate of the UE based on audio measurements.

As will be appreciated, a technical advantage of method 1400 is that accurate positioning estimates can be obtained in an energy-efficient way. Additionally, deployment cost may be reduced by the availability of audio components in existing infrastructure and/or user devices. In addition, aspects of the current disclosure can allow for accurate positioning in locations where vision-based positioning is restricted or prohibited for privacy reasons.

FIG. 15 illustrates an example method 1500 of communication, according to aspects of the disclosure. In an aspect, method 1500 may be performed by a user equipment (e.g., any of the user equipments described herein).

At 1510, the user equipment obtains one or more measurements of radiofrequency (RF) signals. In some implementations, operation 1510 can be performed, for example, using WWAN transceiver(s) 310, short range transceiver(s) 320, processor(s) 332, memory 340, and/or positioning component(s) 342 of UE 302, which may be considered means (structure) for performing operation 1510.

At 1520, the user equipment receives audio positioning configuration information from a network entity. In some implementations, operation 1520 can be performed, for example, using WWAN transceiver(s) 310, short range transceiver(s) 320, processor(s) 332, memory 340, and/or positioning component(s) 342 of UE 302, which may be considered means (structure) for performing operation 1520.

At 1530, the user equipment transmits audio signals, detects audio signals, or both, according to the audio positioning configuration information. In some implementations, operation 1530 can be performed, for example, using WWAN transceiver(s) 310, short range transceiver(s) 320, processor(s) 332, memory 340, and/or positioning component(s) 342 of UE 302, which may be considered means (structure) for performing operation 1530.

At 1540, the user equipment transmits information indicative of the detected audio signals, the transmitted audio signals, or both to the network entity. In some implementations, operation 1540 can be performed, for example, using WWAN transceiver(s) 310, short range transceiver(s) 320, processor(s) 332, memory 340, and/or positioning component(s) 342 of UE 302, which may be considered means (structure) for performing operation 1540.

As will be appreciated, a technical advantage of method 1500 is a user equipment can be accurately positioned in an energy-efficient way, since audio positioning may be less energy consuming than (for example) vision-based positioning. In addition, aspects of the current disclosure can allow for accurate positioning in locations where vision-based positioning is restricted or prohibited for privacy reasons.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method at a network entity comprising: receiving radiofrequency (RF) signaling from a user equipment (UE); determining to activate audio positioning for the UE based on one or more criteria; transmitting audio positioning configuration information to the UE; and receiving positioning information for the UE in accordance with the audio positioning configuration information, the positioning information for the UE including audio measurement information or a location estimate of the UE based on audio measurements.

Clause 2. The method of clause 1, wherein the one or more criteria comprise one or more vision based criteria, one or more RF based criteria, or a combination thereof.

Clause 3. The method of clause 2, wherein the one or more vision based criteria, one or more RF based criteria, or a combination thereof comprises an RF signal quality; an indication of partial or full visual occlusion; an indication of a vision restricted area; an indication of position quality for a position determined based on RF measurements, vision information, or both; or a combination thereof.

Clause 4. The method of any of clauses 1 to 3, wherein receiving the RF signaling from the UE comprises receiving UE audio positioning capability, UE battery status, UE connectivity status, UE audio sampling frequency capability, UE audio bandwidth range capability, UE microphone transmission capability, UE audio protocol capability, or a combination thereof.

Clause 5. The method of any of clauses 1 to 4, wherein the audio positioning configuration information comprises configuration of audio frequency resources to obtain audio positioning information, wherein the network entity is configured to schedule audio positioning for a plurality of UEs including the UE and further comprising: transmitting different audio positioning configuration information to a different UE included in the plurality of UEs; and wherein the different audio positioning configuration information for the different UE comprises configuration of different audio frequency resources to obtain audio positioning information, and wherein the audio frequency resources and the different audio frequency resources are orthogonal.

Clause 6. The method of clause 5 wherein the audio frequency resources and the different audio frequency resources are included in a frequency range from 15 kHz to 30 KHz.

Clause 7. The method of any of clauses 1 to 6, wherein the positioning information for the UE includes: audio measurement information received from the UE, audio measurement information received from one or more audio devices separate from the UE, or both; and RF positioning information or vision positioning information or both, wherein the RF positioning information, vision positioning information, or both is received from the UE, received from one or more vision devices separate from the UE, received from one or more RF devices separate from the UE, or a combination thereof.

Clause 8. The method of clause 7, further comprising: estimating a position of the UE based on the audio measurement information and further based on the RF positioning information, the vision positioning information, or both.

Clause 9. The method of any of clauses 1 to 8, wherein the positioning information for the UE is associated with a device identifier for the UE and an audio identifier for the UE.

Clause 10. The method of clause 9, further comprising: using the audio identifier to associate the audio measurement information or the location estimate of the UE based on audio measurements with RF positioning information for the UE, vision positioning information for the UE, or both.

Clause 11. The method of any of clauses 1 to 10, further comprising: detecting a trigger condition to perform device-free positioning of a target not in communication with the network entity; configuring one or more audio devices to perform positioning of the target using transmitted audio signals, received audio signals, or both; and receiving audio signal measurement information for the target or an indication of the position of the target from the one or more audio devices.

Clause 12. The method of clause 11, wherein the one or more audio devices comprise one or more on-site audio devices including one or more speakers, one or more microphones, or a combination thereof.

Clause 13. The method of any of clauses 11 to 12, wherein the trigger condition is based on a time since receiving a communication from the target exceeding a threshold time, based on detecting an alarm, or a combination thereof.

Clause 14. The method of any of clauses 1 to 13, wherein receiving positioning information for the UE comprises receiving audio signal power measurement information, audio signal direction measurement information, audio signal phase measurement information, audio time of receipt measurement information, audio time difference of arrival measurement information, or a combination thereof.

Clause 15. The method of any of clauses 1 to 14, wherein the audio positioning configuration information comprises configuration information for the UE to: detect audio signals from one or more infrastructure speakers using one or more audio receivers, the audio signals from the one or more infrastructure speakers transmitted according to an audio signal transmission protocol.

Clause 16. The method of any of clauses 1 to 15, further comprising: activating one or more infrastructure audio devices to generate audio signals according to a time and frequency configuration, and wherein receiving the positioning information for the UE comprises receiving an indication of a time of receipt at the UE for at least some of the audio signals generated according to the time and frequency configuration.

Clause 17. The method of any of clauses 1 to 16, wherein the audio positioning configuration information transmitted to the UE comprises configuration information to generate audio signals according to a time and frequency configuration, and wherein receiving the positioning information for the UE comprises receiving an indication of time of receipt of the audio signals generated according to the time and frequency configuration at one or more infrastructure audio devices.

Clause 18. A method of wireless communication for a user equipment (UE) comprising: obtaining one or more measurements of radiofrequency (RF) signals; receiving audio positioning configuration information from a network entity; transmitting audio signals, detecting audio signals, or both, according to the audio positioning configuration information; and transmitting information indicative of the detected audio signals, the transmitted audio signals, or both to the network entity.

Clause 19. The method of clause 18, wherein the information indicative of the detected audio signals, the transmitted audio signals, or both comprises a location estimate of the UE based at least in part on the detected audio signals.

Clause 20. The method of any of clauses 18 to 19, wherein detecting audio signals according to the audio positioning configuration information comprises detecting reception timing of one or more audio signals transmitted from one or more infrastructure speakers with a microphone according to the audio positioning configuration information.

Clause 21. The method of clause 20, wherein detecting reception timing of the one or more audio signals transmitted from the one or more infrastructure speakers with the microphone comprises detecting a time difference of arrival between audio signals received from different infrastructure speakers.

Clause 22. The method of any of clauses 20 to 21, wherein detecting reception timing of one or more audio signals transmitted from one or more infrastructure speakers comprises detecting a time of arrival for the audio signals.

Clause 23. The method of any of clauses 18 to 22, further comprising: subsequently receiving an indication to deactivate audio positioning from the network entity; and performing RF-based positioning, vison-based positioning, or a combination thereof in response to receiving the indication to deactivate the audio positioning.

Clause 24. The method of any of clauses 18 to 23, wherein transmitting information indicative of the detected audio signals, the transmitted audio signals, or both to the network entity comprises transmitting an indication of a round trip time.

Clause 25. The method of any of clauses 18 to 24, wherein the audio positioning configuration information includes frequency configuration information and time configuration information.

Clause 26. The method of clause 25, wherein the frequency configuration information comprises one or more tones at predefined frequencies, and wherein the time configuration information comprises one or more time slots.

Clause 27. A network entity, comprising: one or more memories; one or more transceivers; and one or more processors communicatively coupled to the one or more memories and the one or more transceivers, the one or more processors, either alone or in combination, configured to: receive, via the one or more transceivers, radiofrequency (RF) signaling from a user equipment (UE); determine to activate audio positioning for the UE based on one or more criteria; transmit, via the one or more transceivers, audio positioning configuration information to the UE; and receive, via the one or more transceivers, positioning information for the UE in accordance with the audio positioning configuration information, the positioning information for the UE including audio measurement information or a location estimate of the UE based on audio measurements.

Clause 28. The network entity of clause 27, wherein the one or more criteria comprise one or more vision based criteria, one or more RF based criteria, or a combination thereof.

Clause 29. The network entity of clause 28, wherein the one or more vision based criteria, one or more RF based criteria, or a combination thereof comprises an RF signal quality; an indication of partial or full visual occlusion; an indication of a vision restricted area; an indication of position quality for a position determined based on RF measurements, vision information, or both; or a combination thereof.

Clause 30. The network entity of any of clauses 27 to 29, wherein, to receive the RF signaling from the UE, the one or more processors, either alone or in combination, are configured to receive UE audio positioning capability, UE battery status, UE connectivity status, UE audio sampling frequency capability, UE audio bandwidth range capability, UE microphone transmission capability, UE audio protocol capability, or a combination thereof.

Clause 31. The network entity of any of clauses 27 to 30, wherein the audio positioning configuration information comprises configuration of audio frequency resources to obtain audio positioning information, wherein the network entity is configured to schedule audio positioning for a plurality of UEs including the UE and wherein the one or more processors, either alone or in combination, are further configured to: transmit, via the one or more transceivers, different audio positioning configuration information to a different UE included in the plurality of UEs; and wherein the different audio positioning configuration information for the different UE comprises configuration of different audio frequency resources to obtain audio positioning information, and wherein the audio frequency resources and the different audio frequency resources are orthogonal.

Clause 32. The network entity of clause 31, wherein the audio frequency resources and the different audio frequency resources are included in a frequency range from 15 kHz to 30 KHz.

Clause 33. The network entity of any of clauses 27 to 32, wherein the positioning information for the UE includes: audio measurement information received from the UE, audio measurement information received from one or more audio devices separate from the UE, or both; and RF positioning information or vision positioning information or both, wherein the RF positioning information, vision positioning information, or both is received from the UE, received from one or more vision devices separate from the UE, received from one or more RF devices separate from the UE, or a combination thereof.

Clause 34. The network entity of clause 33, wherein the one or more processors, either alone or in combination, are further configured to: estimate a position of the UE based on the audio measurement information and further based on the RF positioning information, the vision positioning information, or both.

Clause 35. The network entity of any of clauses 27 to 34, wherein the positioning information for the UE is associated with a device identifier for the UE and an audio identifier for the UE.

Clause 36. The network entity of clause 35, wherein the one or more processors, either alone or in combination, are further configured to: use the audio identifier to associate the audio measurement information or the location estimate of the UE based on audio measurements with RF positioning information for the UE, vision positioning information for the UE, or both.

Clause 37. The network entity of any of clauses 27 to 36, wherein the one or more processors, either alone or in combination, are further configured to: detect a trigger condition to perform device-free positioning of a target not in communication with the network entity; configure one or more audio devices to perform positioning of the target using transmitted audio signals, received audio signals, or both; and receive, via the one or more transceivers, audio signal measurement information for the target or an indication of the position of the target from the one or more audio devices.

Clause 38. The network entity of clause 37, wherein the one or more audio devices comprise one or more on-site audio devices including one or more speakers, one or more microphones, or a combination thereof.

Clause 39. The network entity of any of clauses 37 to 38, wherein the trigger condition is based on a time since receiving a communication from the target exceeding a threshold time, based on detecting an alarm, or a combination thereof.

Clause 40. The network entity of any of clauses 27 to 39, wherein, to receive positioning information for the UE, the one or more processors, either alone or in combination, are configured to receive audio signal power measurement information, audio signal direction measurement information, audio signal phase measurement information, audio time of receipt measurement information, audio time difference of arrival measurement information, or a combination thereof.

Clause 41. The network entity of any of clauses 27 to 40, wherein the audio positioning configuration information comprises configuration information for the UE to: detect audio signals from one or more infrastructure speakers using one or more audio receivers, the audio signals from the one or more infrastructure speakers transmitted according to an audio signal transmission protocol.

Clause 42. The network entity of any of clauses 27 to 41, wherein the one or more processors, either alone or in combination, are further configured to: activate one or more infrastructure audio devices to generate audio signals according to a time and frequency configuration, and wherein the one or more processors are configured to receive the positioning information for the UE by receiving an indication of a time of receipt at the UE for at least some of the audio signals generated according to the time and frequency configuration.

Clause 43. The network entity of any of clauses 27 to 42, wherein the audio positioning configuration information transmitted to the UE comprises configuration information to generate audio signals according to a time and frequency configuration, and wherein the one or more processors are configured to receive the positioning information for the UE by receiving an indication of time of receipt of the audio signals generated according to the time and frequency configuration at one or more infrastructure audio devices.

Clause 44. A user equipment, comprising: one or more memories; one or more transceivers; and one or more processors communicatively coupled to the one or more memories and the one or more transceivers, the one or more processors, either alone or in combination, configured to: obtain one or more measurements of radiofrequency (RF) signals; receive, via the one or more transceivers, audio positioning configuration information from a network entity; transmit, via the one or more transceivers, audio signals, detecting audio signals, or both, according to the audio positioning configuration information; and transmit, via the one or more transceivers, information indicative of the detected audio signals, the transmitted audio signals, or both to the network entity.

Clause 45. The user equipment of clause 44, wherein the information indicative of the detected audio signals, the transmitted audio signals, or both comprises a location estimate of the UE based at least in part on the detected audio signals.

Clause 46. The user equipment of any of clauses 44 to 45, wherein, to detect audio signals according to the audio positioning configuration information, the one or more processors, either alone or in combination, are configured to detect reception timing of one or more audio signals transmitted from one or more infrastructure speakers with a microphone according to the audio positioning configuration information.

Clause 47. The user equipment of clause 46, wherein, to detect reception timing of the one or more audio signals transmitted from the one or more infrastructure speakers with the microphone, the one or more processors, either alone or in combination, are configured to detect a time difference of arrival between audio signals received from different infrastructure speakers.

Clause 48. The user equipment of any of clauses 46 to 47, wherein, to detect reception timing of one or more audio signals transmitted from one or more infrastructure speakers, the one or more processors, either alone or in combination, are configured to detect a time of arrival for the audio signals.

Clause 49. The user equipment of any of clauses 44 to 48, wherein the one or more processors, either alone or in combination, are further configured to: subsequently receive, via the one or more transceivers, an indication to deactivate audio positioning from the network entity; and perform RF-based positioning, vison-based positioning, or a combination thereof in response to receiving the indication to deactivate the audio positioning.

Clause 50. The user equipment of any of clauses 44 to 49, wherein, to transmit information indicative of the detected audio signals, the transmitted audio signals, or both to the network entity, the one or more processors, either alone or in combination, are configured to transmit an indication of a round trip time.

Clause 51. The user equipment of any of clauses 44 to 50, wherein the audio positioning configuration information includes frequency configuration information and time configuration information.

Clause 52. The user equipment of clause 51, wherein the frequency configuration information comprises one or more tones at predefined frequencies, and wherein the time configuration information comprises one or more time slots.

Clause 53. A network entity, comprising: means for receiving radiofrequency (RF) signaling from a user equipment (UE); means for determining to activate audio positioning for the UE based on one or more criteria; means for transmitting audio positioning configuration information to the UE; and means for receiving positioning information for the UE in accordance with the audio positioning configuration information, the positioning information for the UE including audio measurement information or a location estimate of the UE based on audio measurements.

Clause 54. The network entity of clause 53, wherein the one or more criteria comprise one or more vision based criteria, one or more RF based criteria, or a combination thereof.

Clause 55. The network entity of clause 54, wherein the one or more vision based criteria, one or more RF based criteria, or a combination thereof comprises an RF signal quality; an indication of partial or full visual occlusion; an indication of a vision restricted area; an indication of position quality for a position determined based on RF measurements, vision information, or both; or a combination thereof.

Clause 56. The network entity of any of clauses 53 to 55, wherein the means for receiving the RF signaling from the UE comprises means for receiving UE audio positioning capability, UE battery status, UE connectivity status, UE audio sampling frequency capability, UE audio bandwidth range capability, UE microphone transmission capability, UE audio protocol capability, or a combination thereof.

Clause 57. The network entity of any of clauses 53 to 56, wherein the audio positioning configuration information comprises configuration of audio frequency resources to obtain audio positioning information, wherein the network entity is configured to schedule audio positioning for a plurality of UEs including the UE and further comprising: means for transmitting different audio positioning configuration information to a different UE included in the plurality of UEs; and wherein the different audio positioning configuration information for the different UE comprises configuration of different audio frequency resources to obtain audio positioning information, and wherein the audio frequency resources and the different audio frequency resources are orthogonal.

Clause 58. The network entity of clause 57, wherein the audio frequency resources and the different audio frequency resources are included in a frequency range from 15 kHz to 30 KHz.

Clause 59. The network entity of any of clauses 53 to 58, wherein the positioning information for the UE includes: audio measurement information received from the UE, audio measurement information received from one or more audio devices separate from the UE, or both; and RF positioning information or vision positioning information or both, wherein the RF positioning information, vision positioning information, or both is received from the UE, received from one or more vision devices separate from the UE, received from one or more RF devices separate from the UE, or a combination thereof.

Clause 60. The network entity of clause 59, further comprising: means for estimating a position of the UE based on the audio measurement information and further based on the RF positioning information, the vision positioning information, or both.

Clause 61. The network entity of any of clauses 53 to 60, wherein the positioning information for the UE is associated with a device identifier for the UE and an audio identifier for the UE.

Clause 62. The network entity of clause 61, further comprising: means for using the audio identifier to associate the audio measurement information or the location estimate of the UE based on audio measurements with RF positioning information for the UE, vision positioning information for the UE, or both.

Clause 63. The network entity of any of clauses 53 to 62, further comprising: means for detecting a trigger condition to perform device-free positioning of a target not in communication with the network entity; means for configuring one or more audio devices to perform positioning of the target using transmitted audio signals, received audio signals, or both; and means for receiving audio signal measurement information for the target or an indication of the position of the target from the one or more audio devices.

Clause 64. The network entity of clause 63, wherein the one or more audio devices comprise one or more on-site audio devices including one or more speakers, one or more microphones, or a combination thereof.

Clause 65. The network entity of any of clauses 63 to 64, wherein the trigger condition is based on a time since receiving a communication from the target exceeding a threshold time, based on detecting an alarm, or a combination thereof.

Clause 66. The network entity of any of clauses 53 to 65, wherein the means for receiving positioning information for the UE comprises means for receiving audio signal power measurement information, audio signal direction measurement information, audio signal phase measurement information, audio time of receipt measurement information, audio time difference of arrival measurement information, or a combination thereof.

Clause 67. The network entity of any of clauses 53 to 66, wherein the audio positioning configuration information comprises configuration information for the UE to: detect audio signals from one or more infrastructure speakers using one or more audio receivers, the audio signals from the one or more infrastructure speakers transmitted according to an audio signal transmission protocol.

Clause 68. The network entity of any of clauses 53 to 67, further comprising: means for activating one or more infrastructure audio devices to generate audio signals according to a time and frequency configuration, and wherein the means for receiving the positioning information for the UE comprises means for receiving an indication of a time of receipt at the UE for at least some of the audio signals generated according to the time and frequency configuration.

Clause 69. The network entity of any of clauses 53 to 68, wherein the audio positioning configuration information transmitted to the UE comprises configuration information to generate audio signals according to a time and frequency configuration, and wherein the means for receiving the positioning information for the UE comprises means for receiving an indication of time of receipt of the audio signals generated according to the time and frequency configuration at one or more infrastructure audio devices.

Clause 70. A user equipment, comprising: means for obtaining one or more measurements of radiofrequency (RF) signals; means for receiving audio positioning configuration information from a network entity; means for transmitting audio signals, detecting audio signals, or both, according to the audio positioning configuration information; and means for transmitting information indicative of the detected audio signals, the transmitted audio signals, or both to the network entity.

Clause 71. The user equipment of clause 70, wherein the information indicative of the detected audio signals, the transmitted audio signals, or both comprises a location estimate of the UE based at least in part on the detected audio signals.

Clause 72. The user equipment of any of clauses 70 to 71, wherein the means for detecting audio signals according to the audio positioning configuration information comprises means for detecting reception timing of one or more audio signals transmitted from one or more infrastructure speakers with a microphone according to the audio positioning configuration information.

Clause 73. The user equipment of clause 72, wherein the means for detecting reception timing of the one or more audio signals transmitted from the one or more infrastructure speakers with the microphone comprises means for detecting a time difference of arrival between audio signals received from different infrastructure speakers.

Clause 74. The user equipment of any of clauses 72 to 73, wherein the means for detecting reception timing of one or more audio signals transmitted from one or more infrastructure speakers comprises means for detecting a time of arrival for the audio signals.

Clause 75. The user equipment of any of clauses 70 to 74, further comprising: means for subsequently receiving an indication to deactivate audio positioning from the network entity; and means for performing RF-based positioning, vison-based positioning, or a combination thereof in response to receiving the indication to deactivate the audio positioning.

Clause 76. The user equipment of any of clauses 70 to 75, wherein the means for transmitting information indicative of the detected audio signals, the transmitted audio signals, or both to the network entity comprises means for transmitting an indication of a round trip time.

Clause 77. The user equipment of any of clauses 70 to 76, wherein the audio positioning configuration information includes frequency configuration information and time configuration information.

Clause 78. The user equipment of clause 77, wherein the frequency configuration information comprises one or more tones at predefined frequencies, and wherein the time configuration information comprises one or more time slots.

Clause 79. A non-transitory computer-readable medium storing computer-executable instructions that, when executed by a network entity, cause the network entity to: receive radiofrequency (RF) signaling from a user equipment (UE); determine to activate audio positioning for the UE based on one or more criteria; transmit audio positioning configuration information to the UE; and receive positioning information for the UE in accordance with the audio positioning configuration information, the positioning information for the UE including audio measurement information or a location estimate of the UE based on audio measurements.

Clause 80. The non-transitory computer-readable medium of clause 79, wherein the one or more criteria comprise one or more vision based criteria, one or more RF based criteria, or a combination thereof.

Clause 81. The non-transitory computer-readable medium of clause 80, wherein the one or more vision based criteria, one or more RF based criteria, or a combination thereof comprises an RF signal quality; an indication of partial or full visual occlusion; an indication of a vision restricted area; an indication of position quality for a position determined based on RF measurements, vision information, or both; or a combination thereof.

Clause 82. The non-transitory computer-readable medium of any of clauses 79 to 81, wherein the computer-executable instructions that, when executed by the network entity, cause the network entity to receive the RF signaling from the UE comprise computer-executable instructions that, when executed by the network entity, cause the network entity to receive UE audio positioning capability, UE battery status, UE connectivity status, UE audio sampling frequency capability, UE audio bandwidth range capability, UE microphone transmission capability, UE audio protocol capability, or a combination thereof.

Clause 83. The non-transitory computer-readable medium of any of clauses 79 to 82, wherein the audio positioning configuration information comprises configuration of audio frequency resources to obtain audio positioning information, wherein the network entity is configured to schedule audio positioning for a plurality of UEs including the UE and further comprising computer-executable instructions that, when executed by the network entity, cause the network entity to: transmit different audio positioning configuration information to a different UE included in the plurality of UEs; and wherein the different audio positioning configuration information for the different UE comprises configuration of different audio frequency resources to obtain audio positioning information, and wherein the audio frequency resources and the different audio frequency resources are orthogonal.

Clause 84. The non-transitory computer-readable medium of clause 83, wherein the audio frequency resources and the different audio frequency resources are included in a frequency range from 15 kHz to 30 kHz.

Clause 85. The non-transitory computer-readable medium of any of clauses 79 to 84, wherein the positioning information for the UE includes: audio measurement information received from the UE, audio measurement information received from one or more audio devices separate from the UE, or both; and RF positioning information or vision positioning information or both, wherein the RF positioning information, vision positioning information, or both is received from the UE, received from one or more vision devices separate from the UE, received from one or more RF devices separate from the UE, or a combination thereof.

Clause 86. The non-transitory computer-readable medium of clause 85, further comprising computer-executable instructions that, when executed by the network entity, cause the network entity to: estimate a position of the UE based on the audio measurement information and further based on the RF positioning information, the vision positioning information, or both.

Clause 87. The non-transitory computer-readable medium of any of clauses 79 to 86, wherein the positioning information for the UE is associated with a device identifier for the UE and an audio identifier for the UE.

Clause 88. The non-transitory computer-readable medium of clause 87, further comprising computer-executable instructions that, when executed by the network entity, cause the network entity to: use the audio identifier to associate the audio measurement information or the location estimate of the UE based on audio measurements with RF positioning information for the UE, vision positioning information for the UE, or both.

Clause 89. The non-transitory computer-readable medium of any of clauses 79 to 88, further comprising computer-executable instructions that, when executed by the network entity, cause the network entity to: detect a trigger condition to perform device-free positioning of a target not in communication with the network entity; configure one or more audio devices to perform positioning of the target using transmitted audio signals, received audio signals, or both; and receive audio signal measurement information for the target or an indication of the position of the target from the one or more audio devices.

Clause 90. The non-transitory computer-readable medium of clause 89, wherein the one or more audio devices comprise one or more on-site audio devices including one or more speakers, one or more microphones, or a combination thereof.

Clause 91. The non-transitory computer-readable medium of any of clauses 89 to 90, wherein the trigger condition is based on a time since receiving a communication from the target exceeding a threshold time, based on detecting an alarm, or a combination thereof.

Clause 92. The non-transitory computer-readable medium of any of clauses 79 to 91, wherein the computer-executable instructions that, when executed by the network entity, cause the network entity to receive positioning information for the UE comprise computer-executable instructions that, when executed by the network entity, cause the network entity to receive audio signal power measurement information, audio signal direction measurement information, audio signal phase measurement information, audio time of receipt measurement information, audio time difference of arrival measurement information, or a combination thereof.

Clause 93. The non-transitory computer-readable medium of any of clauses 79 to 92, wherein the audio positioning configuration information comprises configuration information for the UE to: detect audio signals from one or more infrastructure speakers using one or more audio receivers, the audio signals from the one or more infrastructure speakers transmitted according to an audio signal transmission protocol.

Clause 94. The non-transitory computer-readable medium of any of clauses 79 to 93, further comprising computer-executable instructions that, when executed by the network entity, cause the network entity to: activate one or more infrastructure audio devices to generate audio signals according to a time and frequency configuration, and wherein receiving the positioning information for the UE comprises receiving an indication of a time of receipt at the UE for at least some of the audio signals generated according to the time and frequency configuration.

Clause 95. The non-transitory computer-readable medium of any of clauses 79 to 94, wherein the audio positioning configuration information transmitted to the UE comprises configuration information to generate audio signals according to a time and frequency configuration, and wherein receiving the positioning information for the UE comprises receiving an indication of time of receipt of the audio signals generated according to the time and frequency configuration at one or more infrastructure audio devices.

Clause 96. A non-transitory computer-readable medium storing computer-executable instructions that, when executed by a user equipment, cause the user equipment to: obtain one or more measurements of radiofrequency (RF) signals; receive audio positioning configuration information from a network entity; transmit audio signals, detecting audio signals, or both, according to the audio positioning configuration information; and transmit information indicative of the detected audio signals, the transmitted audio signals, or both to the network entity.

Clause 97. The non-transitory computer-readable medium of clause 96, wherein the information indicative of the detected audio signals, the transmitted audio signals, or both comprises a location estimate of the UE based at least in part on the detected audio signals.

Clause 98. The non-transitory computer-readable medium of any of clauses 96 to 97, wherein the computer-executable instructions that, when executed by the user equipment, cause the user equipment to detect audio signals according to the audio positioning configuration information comprise computer-executable instructions that, when executed by the user equipment, cause the user equipment to detect reception timing of one or more audio signals transmitted from one or more infrastructure speakers with a microphone according to the audio positioning configuration information.

Clause 99. The non-transitory computer-readable medium of clause 98, wherein the computer-executable instructions that, when executed by the user equipment, cause the user equipment to detect reception timing of the one or more audio signals transmitted from the one or more infrastructure speakers with the microphone comprise computer-executable instructions that, when executed by the user equipment, cause the user equipment to detect a time difference of arrival between audio signals received from different infrastructure speakers.

Clause 100. The non-transitory computer-readable medium of any of clauses 98 to 99, wherein the computer-executable instructions that, when executed by the user equipment, cause the user equipment to detect reception timing of one or more audio signals transmitted from one or more infrastructure speakers comprise computer-executable instructions that, when executed by the user equipment, cause the user equipment to detect a time of arrival for the audio signals.

Clause 101. The non-transitory computer-readable medium of any of clauses 96 to 100, further comprising computer-executable instructions that, when executed by the user equipment, cause the user equipment to: subsequently receive an indication to deactivate audio positioning from the network entity; and perform RF-based positioning, vison-based positioning, or a combination thereof in response to receiving the indication to deactivate the audio positioning.

Clause 102. The non-transitory computer-readable medium of any of clauses 96 to 101, wherein the computer-executable instructions that, when executed by the user equipment, cause the user equipment to transmit information indicative of the detected audio signals, the transmitted audio signals, or both to the network entity comprise computer-executable instructions that, when executed by the user equipment, cause the user equipment to transmit an indication of a round trip time.

Clause 103. The non-transitory computer-readable medium of any of clauses 96 to 102, wherein the audio positioning configuration information includes frequency configuration information and time configuration information.

Clause 104. The non-transitory computer-readable medium of clause 103, wherein the frequency configuration information comprises one or more tones at predefined frequencies, and wherein the time configuration information comprises one or more time slots.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A network entity, comprising:
one or more memories;
one or more transceivers; and
one or more processors communicatively coupled to the one or more memories and the one or more transceivers, the one or more processors, either alone or in combination, configured to:
receive, via the one or more transceivers, radiofrequency (RF) signaling from a user equipment (UE);
determine to activate audio positioning for the UE based on one or more criteria;
transmit, via the one or more transceivers, audio positioning configuration information to the UE; and
receive, via the one or more transceivers, positioning information for the UE in accordance with the audio positioning configuration information, the positioning information for the UE including audio measurement information or a location estimate of the UE based on audio measurements.

2. The network entity of claim 1, wherein the one or more criteria comprise one or more vision based criteria, one or more RF based criteria, or a combination thereof.

3. The network entity of claim 2, wherein the one or more vision based criteria, one or more RF based criteria, or a combination thereof comprises an RF signal quality; an indication of partial or full visual occlusion; an indication of a vision restricted area; an indication of position quality for a position determined based on RF measurements, vision information, or both; or a combination thereof.

4. The network entity of claim 1, wherein, to receive the RF signaling from the UE, the one or more processors, either alone or in combination, are configured to receive UE audio positioning capability, UE battery status, UE connectivity status, UE audio sampling frequency capability, UE audio bandwidth range capability, UE microphone transmission capability, UE audio protocol capability, or a combination thereof.

5. The network entity of claim 1, wherein the audio positioning configuration information comprises configuration of audio frequency resources to obtain audio positioning information, wherein the network entity is configured to schedule audio positioning for a plurality of UEs including the UE and wherein the one or more processors, either alone or in combination, are further configured to:
transmit, via the one or more transceivers, different audio positioning configuration information to a different UE included in the plurality of UEs; and
wherein the different audio positioning configuration information for the different UE comprises configuration of different audio frequency resources to obtain audio positioning information, and wherein the audio frequency resources and the different audio frequency resources are orthogonal.

6. The network entity of claim 5, wherein the audio frequency resources and the different audio frequency resources are included in a frequency range from 15 kHz to 30 kHz.

7. The network entity of claim 1, wherein the positioning information for the UE includes:
audio measurement information received from the UE, audio measurement information received from one or more audio devices separate from the UE, or both; and
RF positioning information or vision positioning information or both, wherein the RF positioning information, vision positioning information, or both is received from the UE, received from one or more vision devices separate from the UE, received from one or more RF devices separate from the UE, or a combination thereof.

8. The network entity of claim 7, wherein the one or more processors, either alone or in combination, are further configured to:
estimate a position of the UE based on the audio measurement information and further based on the RF positioning information, the vision positioning information, or both.

9. The network entity of claim 1, wherein the positioning information for the UE is associated with a device identifier for the UE and an audio identifier for the UE.

10. The network entity of claim 9, wherein the one or more processors, either alone or in combination, are further configured to:
use the audio identifier to associate the audio measurement information or the location estimate of the UE based on audio measurements with RF positioning information for the UE, vision positioning information for the UE, or both.

11. The network entity of claim 1, wherein the one or more processors, either alone or in combination, are further configured to:
detect a trigger condition to perform device-free positioning of a target not in communication with the network entity;
configure one or more audio devices to perform positioning of the target using transmitted audio signals, received audio signals, or both; and
receive, via the one or more transceivers, audio signal measurement information for the target or an indication of the position of the target from the one or more audio devices.

12. The network entity of claim 11, wherein the one or more audio devices comprise one or more on-site audio devices including one or more speakers, one or more microphones, or a combination thereof.

13. The network entity of claim 11, wherein the trigger condition is based on a time since receiving a communication from the target exceeding a threshold time, based on detecting an alarm, or a combination thereof.

14. The network entity of claim 1, wherein, to receive positioning information for the UE, the one or more processors, either alone or in combination, are configured to receive audio signal power measurement information, audio signal direction measurement information, audio signal phase measurement information, audio time of receipt measurement information, audio time difference of arrival measurement information, or a combination thereof.

15. The network entity of claim 1, wherein the audio positioning configuration information comprises configuration information for the UE to:
detect audio signals from one or more infrastructure speakers using one or more audio receivers, the audio signals from the one or more infrastructure speakers transmitted according to an audio signal transmission protocol.

16. The network entity of claim 1, wherein the one or more processors, either alone or in combination, are further configured to:
activate one or more infrastructure audio devices to generate audio signals according to a time and frequency configuration, and wherein the one or more processors are configured to receive the positioning information for the UE by receiving an indication of a time of receipt at the UE for at least some of the audio signals generated according to the time and frequency configuration.

17. The network entity of claim 1, wherein the audio positioning configuration information transmitted to the UE comprises configuration information to generate audio signals according to a time and frequency configuration, and wherein the one or more processors are configured to receive the positioning information for the UE by receiving an indication of time of receipt of the audio signals generated according to the time and frequency configuration at one or more infrastructure audio devices.

18. A user equipment (UE), comprising:
one or more memories;
one or more transceivers; and
one or more processors communicatively coupled to the one or more memories and the one or more transceivers, the one or more processors, either alone or in combination, configured to:
obtain one or more measurements of radiofrequency (RF) signals;
receive, via the one or more transceivers, audio positioning configuration information from a network entity;
transmit, via the one or more transceivers, audio signals, detecting audio signals, or both, according to the audio positioning configuration information; and
transmit, via the one or more transceivers, information indicative of the detected audio signals, the transmitted audio signals, or both to the network entity.

19. The user equipment of claim 18, wherein the information indicative of the detected audio signals, the transmitted audio signals, or both comprises a location estimate of the UE based at least in part on the detected audio signals.

20. The user equipment of claim 18, wherein, to detect audio signals according to the audio positioning configuration information, the one or more processors, either alone or in combination, are configured to detect reception timing of one or more audio signals transmitted from one or more infrastructure speakers with a microphone according to the audio positioning configuration information.

21. The user equipment of claim 20, wherein, to detect reception timing of the one or more audio signals transmitted from the one or more infrastructure speakers with the microphone, the one or more processors, either alone or in combination, are configured to detect a time difference of arrival between audio signals received from different infrastructure speakers.

22. The user equipment of claim 20, wherein, to detect reception timing of one or more audio signals transmitted from one or more infrastructure speakers, the one or more processors, either alone or in combination, are configured to detect a time of arrival for the audio signals.

23. The user equipment of claim 18, wherein the one or more processors, either alone or in combination, are further configured to:
subsequently receive, via the one or more transceivers, an indication to deactivate audio positioning from the network entity; and
perform RF-based positioning, vison-based positioning, or a combination thereof in response to receiving the indication to deactivate the audio positioning.

24. The user equipment of claim 18, wherein, to transmit information indicative of the detected audio signals, the transmitted audio signals, or both to the network entity, the one or more processors, either alone or in combination, are configured to transmit an indication of a round trip time.

25. The user equipment of claim 18, wherein the audio positioning configuration information includes frequency configuration information and time configuration information.

26. The user equipment of claim 25, wherein the frequency configuration information comprises one or more tones at predefined frequencies, and wherein the time configuration information comprises one or more time slots.

27. A method at a network entity comprising:
receiving radiofrequency (RF) signaling from a user equipment (UE);
determining to activate audio positioning for the UE based on one or more criteria;
transmitting audio positioning configuration information to the UE; and
receiving positioning information for the UE in accordance with the audio positioning configuration information, the positioning information for the UE including audio measurement information or a location estimate of the UE based on audio measurements.

28. The method of claim 27, wherein the one or more criteria comprise one or more vision based criteria, one or more RF based criteria, or a combination thereof.

29. A method of wireless communication for a user equipment (UE) comprising:
obtaining one or more measurements of radiofrequency (RF) signals;
receiving audio positioning configuration information from a network entity;
transmitting audio signals, detecting audio signals, or both, according to the audio positioning configuration information; and
transmitting information indicative of the detected audio signals, the transmitted audio signals, or both to the network entity.

30. The method of claim 29, wherein the information indicative of the detected audio signals, the transmitted audio signals, or both comprises a location estimate of the UE based at least in part on the detected audio signals.
